(19) United States
(12) Patent Application Publication
(10) Pub. No.: US 2022/0169545 A1
(43) Pub. Date: Jun. 2, 2022

(54) METHODS AND COMPOSITIONS FOR TREATING PRODUCED WATER

(71) Applicant: KEMIRA OYJ, HELSINKI (FI)

(72) Inventors: Mehrdad HESAMPOUR, Espoo (FI); Fazlollah AZARNOUSH, Helsinki (FI); Tiina PAJUNEN, Helsinki (FI); Iris PORAT, Mableton, GA (US); Miguel PELAEZ, Decatur, GA (US)

(21) Appl. No.: 17/437,865

(22) PCT Filed: Mar. 12, 2020
(86) PCT No.: PCT/US2020/022339

§ 371 Date: Sep. 10, 2021

Related U.S. Application Data
(60) Provisional application No. 62/817,131, filed on Mar. 12, 2019.

(30) Foreign Application Priority Data
Mar. 27, 2019 (FI) 20195238

(51) Int. Cl. C02F 1/56; C02F 1/52

(52) U.S. Cl. CPC C02F 1/56; C02F 2103/10; C02F 1/5245

(57) ABSTRACT

The present embodiments generally relate to the treatment of produced water such as produced water resulting from an industrial process such as one involving the use of copious amounts of water and the addition of one or more polymers such as water soluble and/or viscosifying or thickening polymers, in particular enhanced oil recovery processes or another processes resulting in polymer flooded produced water. These treatment methods include contacting the produced water with one or more PACl-based coagulants, wherein said treatment may result in desired effects, such as, for example, a reduction of the viscosity of said produced water and/or the removal of polymers which are contained therein.

### RELATED APPLICATIONS

This application claims priority to U.S. Provisional Application No. 62/817,131, filed on Mar. 12, 2019; and to Finnish Application No. 20195238, filed on Mar. 27, 2019.

### FIELD OF THE ART

The present disclosure generally relates to a method for treating produced water which comprises one or more water soluble polymers, e.g., from an enhanced oil recovery process, comprising treating said produced water with one or more polyaluminum chloride-based coagulants, wherein said treatment may result in desired effects, e.g., a reduction of the viscosity of said produced water and/or the removal of polymers which are contained therein.

### BACKGROUND

Enhanced oil recovery (EOR) is a technique that can be used to increase the amount of unrefined petroleum (e.g., crude oil) that may be extracted from an oil reservoir (e.g., an oil field). By way of example, using EOR, about 40-60% of the reservoir's original oil can typically be extracted, compared with only 20-40% using traditional primary and secondary recovery techniques (e.g., by water injection or natural gas injection). One type of EOR technique is polymer flooding, which typically involves the injection of large volumes of a polymer solution into a subterranean oil reservoir. The polymer solution can mobilize the oil towards a production well where it can be recovered. The produced water from a polymer flooding process can include various chemicals. These chemicals, including the polymer(s) used for the polymer flooding, may affect the viscosity and viscoelastic properties of the produced water. The properties and contents of the produced water can also influence discharge of the produced water, e.g., into the sea, as polymers that may be used for polymer flooding, e.g., partially hydrolyzed polyacrylamide (HPAM), typically may not be readily bio-degradable according to current regulations.

### BRIEF SUMMARY

The present disclosure generally relates to a method for treating produced water comprising one or more water soluble polymers, which comprises treating said produced water with one or more polyaluminum chloride-based (PACl-based) coagulants. In some embodiments, said one or more PACl-based coagulants may be modified with one or more polyamine-based polymers. In some embodiments, said one or more PACl-based coagulants may be modified with at least two polyamine-based polymers. In some embodiments, said one or more PACl-based coagulants may be modified with one or more cationic polyacrylamides (cPAMs). In some embodiments, said one or more cPAMs may comprise a copolymer comprising one or more acrylamide monomers or one or more methacrylamide monomers and one or more cationic monomers. In some embodiments, said one or more cPAMs may comprise an acrylamide or methacrylamide based polymer that is also treated after the polymerization to render it cationic, for example, by using Hofmann or Mannich reactions. In some embodiments, said one or more cPAMs may comprise a copolymer comprising one or more acrylamide monomers and one or more methacrylamide monomers, e.g., wherein said copolymer has an average molecular weight (MW) of between about 300 000-3 000 000 g/mol, between about 400 000-2 000 000 g/mol, between about, 500 000-1 500 000 g/mol, or between about 500 000-1 000 000 g/mol. In some embodiments, said one or more PACl-based coagulants may be modified with one or more polyDADMACs.

In some embodiments, said one or more PACl-based coagulants may be modified with one or more polyamine-based polymers and/or one or more cPAMs and/or one or more polyDADMACs. In some embodiments, said one or more PACl-based coagulants may be modified with one or more polyamine-based polymers and/or one or more cPAMs. In some embodiments, said one or more PACl-based coagulants may be modified with one or more polyDADMACs and/or one or more polyamine-based polymers. In some embodiments, said one or more PACl-based coagulants may be modified with one or more polyDADMACs and/or one or more cPAMs. In some embodiments, the produced water may be treated with an amount of said one or more PACl-based coagulants that is effective to effect one or more of the following: reduce the viscosity of the produced water; result in less sticky, floating floc; reduce the TOC of said produced water; increase the COD removal rate; reduce the oil concentration of the produced water; affect salinity in a desired manner; affect zeta potential in a desired manner; decrease the absolute charge of the treated produced water; affect the charge of the produced water in a desirable manner, i.e., the absolute charge may be reduced; the alkalinity may be altered; zeta potential/salinity may be affected; the amount of micro floc may be reduced; the sludge volume may decrease; the sludge density may increase; the sludge dryness may increase; the sludge dewatering may increase; the rate of floc formation may increase; oil removal may be enhanced; the settling rate may increase; the amount of polymer removed from produced water may increase; and/or the dewatering efficiency may increase, and the like, or any combination of the foregoing; as compared to other coagulants used to treat produced water and/or as compared to untreated produced water. In some embodiments, the produced water may be treated with an amount of said one or more PACl-based coagulants that is effective to reduce the TOC of said produced water, such as by 80% or less, 80% or more, 82% or more, 84% or more, 86% or more, 88% or more, 90% or more, or 92% or more.

In some embodiments, an amount of said one or more PACls used to treat said produced water may be an amount that is effective to reduce the viscosity of the produced water and/or to remove one or more polymers from the produced water. In some embodiments, treatment of the produced water with said one or more PACl-based coagulants may result in reduction of the amount of polymer comprised in the produced water by about 50% or less, by about 50% or more, by about 55% or more, by about 60% or more, by about 65% or more, by about 70% or more, by about 75% or more, by about 80% or more, by about 85% or more, by about 90% or more, by about 95% or more, or by about 98% or more as compared to untreated produced water. In some embodiments, treatment of the produced water with one or more PACl-based coagulants may result in a reduction of the viscosity of the produced water by about 10% or less, about 10% or more, about 15% or more, about 20% or more, about 25% or more, about 30% or more, about 35% or more, about 40% or more, about 45% or more, about 50% or more, about 55% or more, about 60% or more, about 65% or more, about 70% or more, about 75% or more, about 80% or more, as compared to untreated produced water. In some embodiments, said produced water may be generated during any part of an enhanced oil recovery process. In some embodiments, said produced water may comprise one or more water soluble thickening or viscosifying polymers. In some embodiments, said produced water may comprise polymer flooded produced water. In some embodiments, treatment of the produced water with one or more PACl-based coagulants may reduce the viscosity to a level that is beneficial for reinjection or which is suitable (e.g., environmentally acceptable) disposal purposes. In some embodiments, said treated produced water may be reused in the same or other industrial processes. In some embodiments, said treated produced water may be reused for polymer injection, backflow water application, and/or water injection. In some embodiments, said treated produced water may be used for skim tank settling. In some embodiments, said produced water may comprise one or more PAMs, such as, for example, any polymers or co-polymers comprising acrylamide moieties, one or more acrylamide (co)polymers, and/or one or more water soluble high molecular weight anionic polyacrylamide-based polymers. In some embodiments, said one or more PAMs may comprise one or more HPAMs and/or one or more DPAMs and/or one or more sulfonated PAMs. In some embodiments, treatment of the produced water may occur on-site, at any onshore oil field, at any offshore oil field, at a treatment facility, at a disposal well, or at any other location where produced water is present and/or treated.

In some embodiments, treatment of the produced water with one or more PACl-based coagulants may result in a sludge volume from about 10% to about 30% of the total volume before a dewatering and/or separation step. In some embodiments, treatment of the produced water with one or more PACl-based coagulants may be effected through a single treatment with said one or more PACl-based coagulants. In some embodiments, said treatment may result in about 0.02 gram or less, 0.02 gram or more, about 0.04 gram or more, about 0.06 gram or more, about 0.08 gram or more, about 0.10 gram or more, about 0.12 gram or more, about 0.14 gram or more, or about 0.16 gram or more of said water soluble and/or viscosifying polymer removed per mMol of Al comprised by said one or more PACl-based coagulants. In some embodiments, said treatment may result in removal of about 40% or less, about 40% or more, about 50% or more, about 60% or more, about 70% or more, about 80% or more, about 90% or more, about 95% or more, about 96% or more, about 97% or more, about 98% or more, or about 99% or more of said one or more water soluble and/or viscosifying polymers comprised by said produced water. In some embodiments, said treatment may result in a COD removal rate of about 50% or less, 50% or more, 60% or more, 70% or more, 80% or more, or 91% or more. In some embodiments, treatment of said produced water with one or more PACl-based coagulants may result in any one or more of the following: less pH depression and/or alkalinity depletion; reduced lime or caustic requirements; reduced sludge volumes; increased sludge density; improved results in higher pH system as compared to other coagulants; minimized pH adjustment; improved filter operation; and/or improved performance in cold water as compared to other coagulants and/or untreated produced water. In some embodiments, said one or more water soluble polymers may comprise one or more high molecular weight polymers. In some embodiments, said one or more water soluble polymers may comprise one or more anionically charged high molecular weight polymers. In some embodiments, treatment of said produced water with one or more PACl-based coagulants may result in a treated produced water which meets desired effluent quality standards. In some embodiments, treatment of said produced water with one or more PACl-based coagulants may be used in combination with one or more additional processes, such as mechanical treatments (e.g., membrane filtration), chemical treatments (e.g., oxidizing agents), and/or biological treatments (e.g., microbiological processes). In some embodiments, said treatment may occur under anaerobic conditions. In some embodiments, said treatment may occur under aerobic conditions.

In some embodiments, PACl, one or more polyamine based polymers, and one or more cPAMs may be added simultaneously, e.g., as a mixture, may be added separately, and/or may be added multiple times. In some embodiments, PACl, one or more polyamine based polymers, and one or more cPAMs may be added in any order and/or in any combination and/or may occur multiple times. In some embodiments, said separate addition of PACl, one or more polyamine-based polymers, and one or more cPAMs may occur in any order, and may occur in combinations, i.e., addition of one polyamine-based polymer and one cPAM occur first, followed by addition of PACl, followed by addition of a second polyamine-based polymer and a second cPAM. In some embodiments, PACl, one or more polyamine based polymers, and one or more cPAMs may be added one or more doses as needed or in intervals, in a stepwise fashion, or in a continuous fashion.

Furthermore, the present disclosure generally relates to a composition suitable for use in treating produced water or a treated produced water composition, comprising one or more PACl-based coagulants, one or more water soluble polymers, and produced water. In some embodiments, said one or more PACl-based coagulants may comprise one or more PAC′-based coagulants modified with one or more polyamine-based polymers. In some embodiments, said one or more PACl-based coagulants may include PACl-based coagulants which are modified with one or more cationic polyacrylamides (cPAMs). In some embodiments, said one or more PACl-based coagulants may include PACl-based coagulants which are modified with one or more polyDADMACs. In some embodiments, said one or more PACl-based coagulants may include PACl-based coagulants which are modified with one or more polyamine-based polymers and/or one or more cPAMs and/or one or more polyDADMACs. In some embodiments, said one or more PACl-based coagulants may include PACl-based coagulants which are modified with one or more polyamine-based polymers and/or one or more cPAMs. In some embodiments, said one or more PACl-based coagulants may include PACl-based coagulants which are modified with one or more polyDADMACs and/or one or more polyamine-based polymers. In some embodiments, said one or more PACl-based coagulants may include PACl-based coagulants which are modified with one or more polyDADMACs and/or one or more cPAMs. In some embodiments, said one or more PACl-based coagulants may comprise one or more PACl-based coagulants modified with at least two polyamine-based polymers. In some embodiments, said composition may comprise one or more PAMs, e.g., polymers or co-polymers comprising acrylamide moieties, e.g., one or more acrylamide (co)polymers, e.g., one or more polymers comprising acrylamide and acrylic acid. In some embodiments, said composition may comprise one or more HPAMs and/or one or more DPAMs and/or one or more sulfonated PAMs. In some embodiments, said composition may comprise one or more water soluble, high molecular weight anionic polyacrylamide-based polymers.

In some embodiments, said produced water may be generated during any part of an enhanced oil recovery process. In some embodiments, said composition may comprise one or more water soluble thickening or viscosifying polymers. In some embodiments, said produced water may comprise polymer flooded produced water. In some embodiments, said produced water may comprise one or more PAMs, e.g., polymers or co-polymers comprising acrylamide moieties, one or more acrylamide (co)polymers, and/or one or more water soluble high molecular weight anionic polyacrylamide-based polymers. In some embodiments, said one or more water soluble polymers may comprise one or more high molecular weight polymers. In some embodiments, said one or more water soluble polymers may comprise one or more anionically charged high molecular weight polymers. In some embodiments, said one or more cPAMs may comprise a copolymer comprising one or more acrylamide monomers or one or more methacrylamide monomers and one or more cationic monomers. In some embodiments, said one or more cPAMs may comprise an acrylamide or methacrylamide based polymer that is also treated after the polymerization to render it cationic, for example, by using Hofmann or Mannich reactions. In some embodiments, said one or more cPAMs may comprise a copolymer comprising one or more acrylamide monomers and one or more methacrylamide monomers, e.g., said copolymer may have an average molecular weight (MW) of between about 300 000-3 000 000 g/mol, between about 400 000-2 000 000 g/mol, between about, 500 000-1 500 000 g/mol, or between about 500 000-1 000 000 g/mol.

### BRIEF DESCRIPTION OF THE SEVERAL VIEWS OF THE DRAWING

In the Examples and below the various Figures are referred to either as “Figure X” or “FIG. X”.

FIG. 1 shows an image of a stock polymer solution that was made in accordance with Example 1.

FIG. 2 shows images of samples comprising polymer and oil in accordance with Example 1.

FIG. 3 shows images of samples that were taken during a treatment method in accordance with Example 1.

FIG. 4 shows images of samples that were taken after settling of said samples in accordance with Example 1.

FIG. 5 shows images of sludge volume measurements of samples in accordance with Example 1.

FIG. 6 shows images of samples that were taking during a treatment method in accordance with Example 1.

FIG. 7 shows images of samples that were taken after settling of said samples in accordance with Example 1.

FIG. 8 shows images of sludge volume measurements of samples in accordance with Example 1.

FIG. 9 shows a schematic of a flow diagram of the test flow loop used for the field trial experiments performed in accordance with Example 2.

FIG. 10 presents data collected regarding the efficiency of polymer removal that resulted from treatment methods in accordance with Example 2.

FIG. 11 presents data collected regarding the efficiency of polymer removal that resulted from treatment methods in accordance with Example 2.

FIG. 12 presents data collected regarding various measurements of treatment effectiveness in accordance with Example 5.

FIG. 13 presents data related to filtration tests that were performed in accordance with Example 5.

### DETAILED DESCRIPTION

### Definitions

As used herein the singular forms “a”, “an”, and “the” include plural referents unless the context clearly dictates otherwise. All technical and scientific terms used herein have the same meaning as commonly understood to one of ordinary skill in the art to which this invention belongs unless clearly indicated otherwise.

As used herein, the term “enhanced oil recovery” or “EOR” (sometimes also known as improved oil recovery (“TOR”) or tertiary mineral oil production) generally refers to techniques for increasing the amount of unrefined petroleum (for example, crude oil) that may be extracted from an oil reservoir, such as an oil field. Examples of EOR techniques include, for example, miscible gas injection (e.g., carbon dioxide flooding), chemical injection, which is sometimes referred to as chemical enhanced oil recovery (“CEOR”), and which includes, for example, polymer flooding, alkaline flooding, surfactant flooding, micellar polymer flooding, conformance control operations, as well as combinations thereof such as alkaline-polymer flooding or alkaline-surfactant-polymer flooding, microbial injection, and thermal recovery (e.g., cyclic steam, steam flooding, or fire flooding). In some embodiments, the EOR operation may include a polymer (“P”) flooding operation, an alkaline-polymer (“AP”) flooding operation, a surfactant-polymer (“SP”) flooding operation, an alkaline-surfactant-polymer (“ASP”) flooding operation, a conformance control operation, or any combination thereof.

As used herein, the terms “polymer flood” or “polymer flooding” generally refer to a chemical enhanced EOR technique that typically involves injecting an aqueous fluid that is viscosified with one or more water-soluble polymers through injection boreholes into an oil reservoir to mobilize oil left behind after primary and/or secondary recovery. As a general result of the injection of one or more polymers, the oil may be forced in the direction of the production borehole, and the oil may be produced through the production borehole. Details of examples of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”, which is herein incorporated by reference in its entirety. One or more surfactants may be injected (or formed in situ) as part of the EOR technique. Surfactants may function to reduce the interfacial tension between the oil and water, which may reduce capillary pressure and improve mobilization of oil. Surfactants may be injected with polymers (e.g., a surfactant-polymer (SP) flood), or formed in-situ (e.g., an alkaline-polymer (AP) flood), or a combination thereof (e.g., an alkaline-surfactant-polymer (ASP) flood). As used herein, the terms “polymer flood” and “polymer flooding” encompass all of these EOR techniques.

As used herein, the term “monomer” generally refers to nonionic monomers, anionic monomers, cationic monomers, zwitterionic monomers, betaine monomers, and amphoteric ion pair monomers.

As used herein, the terms “polymer,” “polymers,” “polymeric,” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, e.g., polymerizing, a particular monomer. Unless otherwise specified, a polymer may also comprise a “copolymer” that may comprise two or more different recurring units that may be formed by, e.g., copolymerizing, two or more different monomers, and/or by chemically modifying one or more recurring units of a precursor polymer. Unless otherwise specified, a polymer or copolymer may also comprise a “terpolymer” that may comprise polymers that may comprise three or more different recurring units. The term “polymer” as used herein is intended to include both the acid form of the polymer as well as its various salts. Polymers may be amphoteric in nature, i.e., containing both anionic and cationic substituents, although not necessarily in the same proportions.

As used herein the term “nonionic monomer” generally refers to a monomer that possesses a neutral charge. Nonionic monomers may comprise but are not limited to comprising monomers selected from the group consisting of acrylamide (“AMD”), acrylic, methacrylic, methacrylamido, vinyl, allyl, ethyl, and the like, all of which may be substituted with a side chain selected from, for example, an alkyl, arylalkyl, dialkyl, ethoxyl, and/or hydrophobic group. In some embodiments, a nonionic monomer may comprise AMD. In some embodiments, nonionic monomers may comprise but are not limited to comprising vinyl amide (e.g., acrylamide, methacrylamide, N-methylacrylamide, N,N-dimethylacrylamide), acryloylmorpholine, acrylate, maleic anhydride, N-vinylpyrrolidone, vinyl acetate, N-vinyl formamide and their derivatives, such as hydroxyethyl (methyl)acrylate CH2=CR—COO—CH2CH2OH (I) and CH2=CR—CO—N(Z1)(Z2) (2) N-substituted (methyl)acrylamide (II). R=H or Me; Z1=5-15C alkyl; 1-3C alkyl substituted by 1-3 phenyl, phenyl or 6-12C cycloalkyl (both optionally substituted) and Z2=H; or Z1 and Z2 are each 3-10C alkyl; (II) is N-tert. hexyl, tert. octyl, methylundecyl, cyclohexyl, benzyl, diphenylmethyl or triphenyl acrylamide. Nonionic monomers further may include dimethylaminoethylacrylate (“DMAEMA”), dimethylaminoethyl methacrylate (“DMAEM”), N-isopropylacrylamide and N-vinyl formamide. Nonionic monomers can be combined, for example to form a terpolymer of acrylamide, N-vinyl formamide, and acrylic acid.

As used herein, the term “anionic monomers” may refer to either anionic monomers that are substantially anionic in whole or (in equilibrium) in part, at a pH in the range of about 4.0 to about 9.0. The “anionic monomers” may be neutral at low pH (from a pH of about 2 to about 6), or to anionic monomers that are anionic at low pH.

Examples of anionic monomers which may be used herein which further may be substituted with other groups include but are not limited to those comprising acrylamide (“AMD”), acrylic, methacrylic, methacrylamido, vinyl, allyl, ethyl, and the like; maleic monomers and the like; calcium diacrylate; and/or any monomer substituted with a carboxylic acid group or salt thereof. In some embodiments, these anionic monomers may be substituted with a carboxylic acid group, and include, for example, acrylic acid, and methacrylic acid. In some embodiments, an anionic monomer which may be used herein may be a (meth)acrylamide monomer wherein the amide group has been hydrolyzed to a carboxyl group. Said monomer may be a derivative or salt of a monomer according to the embodiments. Additional examples of anionic monomers comprise but are not limited to those comprising sulfonic acids or a sulfonic acid group, or both. In some embodiments, the anionic monomers which may be used herein may comprise a sulfonic function that may comprise, for example, acrylamide tertiary butyl sulfonic acid (also known as 2-acrylamido-2-methylpropane sulfonic acid or N-t-butyl acrylamide sulfonic acid) (“ATBS”); vinylsulfonic acid; 4-styrenesulfonic acid; and/or any salts of any of these moieties/monomers. In some embodiments, anionic monomers may comprise organic acids. In some embodiments, anionic monomers may comprise acrylic acid, methacrylic acid, maleic acid, itaconic acid, acrylamido methylpropane sulfonic acid, vinylphosphonic acid, styrene sulfonic acid and their salts such as sodium, ammonium and potassium. Anionic monomers can be combined, for example, to form a terpolymer of acrylamide, acrylic acid and acrylamide tertiary butyl sulfonic acid.

As used herein, the term “cationic monomer” generally refers to a monomer that possesses a positive charge. Examples of cationic monomers may comprise but are not limited to those comprising acryloyloxy ethyl trimethyl ammonium chloride (“AETAC”), methacryloyloxyethyltrimethylammonium chloride, methacrylamidopropyltrimethylammonium chloride (“MAPTAC”), acrylamidopropyltrimethylammonium chloride, methacryloyloxyethyldimethylammonium sulfate, dimethylaminoethyl acrylate, dime thylaminopropylmethacrylamide, Q6, Q6o 4, and/or diallyldimethylammonium chloride (“DADMAC”).

Said cationic monomers may also comprise but are not limited to comprising dialkylaminoalkyl acrylates and methacrylates and their quaternary or acid salts, including, but not limited to, dimethylaminoethyl acrylate methyl chloride quaternary salt (“DMAEA.MCQ”), dimethylaminoethyl acrylate methyl sulfate quaternary salt (“DMAEM.MCQ”), dimethyaminoethyl acrylate benzyl chloride quaternary salt (“DMAEA.BCQ”), dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate and diallyldialkylammonium halides such as diallyldiethylammonium chloride and diallyldimethyl ammonium chloride. Alkyl groups may generally but are not limited to those comprising C₁₋₈ alkyl groups. In some embodiments, cationic monomers may comprise quaternary ammonium or acid salts of vinyl amide, vinyl carboxylic acid, methacrylate and their derivatives. Cationic monomers may comprise but are not limited to comprising monomers selected from the group consisting of dimethylaminoethylacrylate methyl chloride quaternary salt, dimethylaminoethylmethacrylate methyl chloride quaternary salt, and diallyldimethyl ammonium chloride. Cationic monomers can be combined, for example, to form a terpolymer of dimethylaminoethylmethacrylate methyl chloride quaternary salt, and diallyldimethyl ammonium chloride and acrylamide.

The term “water-soluble polymer” generally refers to any polymer that may dissolve, disperse, or swell in water. Said polymers may modify the physical properties of aqueous systems undergoing gelation, thickening, viscosification, or emulsification/stabilization. Said polymers may perform a variety of functions, including but not limited to use as dispersing and suspending agents, stabilizers, thickeners (“thickening polymer” and/or “thickening agent”), viscosifiers (“visosifying polymer” and/or “visosifying agent”), gellants, flocculants and coagulants, film-formers, humectants, binders, and lubricants.

In the context of polymer flooding, a water-soluble polymer may include, but not be limited to including, one or more high molecular weight polyacrylamide and/or copolymers of acrylamide and further monomers, for example, vinylsulfonic acid or acrylic acid. Polyacrylamide may be partly hydrolyzed polyacrylamide (“HPAM”), in which some of the acrylamide units have been hydrolyzed to acrylic acid. In some embodiments, a water soluble polymer may comprise a high molecular weight anionic polyacrylamide based polymer. Naturally occurring polymers may also be used, for example, xanthan or polyglycosylglucan. Naturally occurring polymers may be used in their natural form and/or in a modified form.

In some embodiments, a water-soluble polymer may comprise one or more acrylamide (co)polymers. In some embodiments, one or more acrylamide (co)polymers may be a polymer useful for enhanced oil recovery (EOR) applications. In a particular embodiment, a water-soluble polymer is a high molecular weight polyacrylamide and/or partially hydrolyzed products thereof.

According to some embodiments, one or more acrylamide (co)polymers may be selected from water-soluble acrylamide (co)polymers. In some embodiments, acrylamide (co)polymers may comprise at least 30% by weight, or at least 50% by weight acrylamide units with respect to the total amount of all monomeric units in the (co)polymer.

Optionally, one or more acrylamide (co)polymers may comprise acrylamide and at least one additional monomer. In some embodiments, an acrylamide (co)polymer may comprise less than about 50%, or less than about 40%, or less than about 30%, or less than about 20% by weight of the at least one additional monomer. In some embodiments, the additional monomer may be a water-soluble, ethylenically unsaturated, in particular monoethylenically unsaturated, monomer. Additional water-soluble monomers may be miscible with water in any ratio, but it is typically sufficient that the monomers dissolve sufficiently in an aqueous phase to copolymerize with acrylamide. In general, the solubility of such additional monomers in water at room temperature may be at least 50 g/L, at least 150 g/L, and/or at least 250 g/L.

Other water soluble monomers may comprise one or more hydrophilic groups. The hydrophilic groups may be functional groups that may comprise atoms selected from the group of O-, N-, S- or P-atoms. Nonlimiting examples of such functional groups comprise carbonyl groups >C═O, ether groups —O—, in particular polyethylene oxide groups —(CH₂—CH₂—O—)ₙ—, where n is preferably a number from 1 to 200, hydroxy groups —OH, ester groups —C(O)O—, primary, secondary or tertiary amino groups, ammonium groups, amide groups —C(O)—NH— or acid groups such as carboxyl groups —COOH, sulfonic acid groups —SO₃H, phosphonic acid groups —PO₃H₂ or phosphoric acid groups —OP(OH)₃.

Some monoethylenically unsaturated monomers comprising acid groups may comprise monomers comprising —COOH groups, such as acrylic acid or methacrylic acid, crotonic acid, itaconic acid, maleic acid or fumaric acid, monomers comprising sulfonic acid groups, such as vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid, or monomers comprising phosphonic acid groups, such as vinylphosphonic acid, allylphosphonic acid, N-(meth)acrylamidoalkylphosphonic acids or (meth)acryloyloxyalkylphosphonic acids. Said monomers may be used as salts.

The —COOH groups in polyacrylamide (co)polymers may be obtained, for example, by copolymerizing acrylamide and monomers comprising —COOH groups and/or, for example, by hydrolyzing derivatives of —COOH groups after polymerization. For example, amide groups —CO—NH₂ of acrylamide when hydrolyzed yield —COOH groups.

Also to be mentioned are monomers which are derivatives of acrylamide, such as, for example, N-alkyl acrylamides and N-alkyl quaternary acrylamides, wherein the alkyl group may be C₂-C₂₈; N-methyl(meth)acrylamide, N,N′-dimethyl(meth)acrylamide, and N-methylolacrylamide; N-vinyl derivatives such as N-vinylformamide, N-vinylacetamide, N-vinylpyrrolidone or N-vinylcaprolactam; and vinyl esters, such as vinyl formate or vinyl acetate. N-vinyl derivatives may be hydrolyzed after polymerization to vinylamine units; vinyl esters to vinyl alcohol units.

Furthermore, monomers may comprise monomers comprising hydroxy and/or ether groups, such as, for example, hydroxyethyl(meth)acrylate, hydroxypropyl(meth)acrylate, allyl alcohol, hydroxyvinyl ethyl ether, hydroxyl vinyl propyl ether, hydroxyvinyl butyl ether or polyethyleneoxide(meth)acrylates.

Other monomers may be monomers comprising ammonium groups, i.e., monomers having cationic groups. Examples of said monomers may comprise salts of 3-trimethylammonium propylacrylamides or 2-trimethylammonium ethyl(meth)acrylates, for example the corresponding chlorides, such as 3-trimethylammonium propylacrylamide chloride (DIMAPAQUAT), and 2-trimethylammonium ethyl methacrylate chloride (MADAME-QUAT).

Yet other monomers may comprise monomers which may cause hydrophobic association of the (co)polymers. Such monomers may comprise, in addition to an ethylenic group and a hydrophilic part, a hydrophobic part.

In some embodiments, one or more acrylamide (co)polymers may optionally comprise crosslinking monomers, i.e., monomers comprising more than one polymerizable group. In certain embodiments, one or more acrylamide (co)polymers may optionally comprise crosslinking monomers in an amount of less than about 0.5%, or about 0.1%, by weight, based on the amount of all monomers.

In some embodiments, one or more acrylamide (co)polymers may comprise at least one monoethylenically unsaturated monomer comprising acid groups, for example monomers that comprise at least one group selected from —COOH, —SO₃H or —PO₃H₂. Examples of such monomers may include, but are not limited to, acrylic acid, methacrylic acid, vinylsulfonic acid, allylsulfonic acid or 2-acrylamido-2-methylpropanesulfonic acid, particularly preferably acrylic acid and/or 2-acrylamido-2-methylpropanesulfonic acid, and most preferred acrylic acid or the salts thereof. In some embodiments, one or more acrylamide (co)polymers, or each of the one or more acrylamide (co) polymers, may comprise 2-acrylamido-2-methylpropanesulfonic acid or salts thereof. The amount of such monomers comprising acid groups may be from about 0.1% to about 70%, about 1% to about 50%, or about 10% to about 50% by weight based on the amount of all monomers according to some embodiments.

In some embodiments, one or more acrylamide (co)polymers may comprise from about 50% to about 90% by weight of acrylamide units and from about 10% to about 50% by weight of acrylic acid units and/or their respective salts. In some embodiments, one or more acrylamide (co)polymers may comprise from about 60% to 80% by weight of acrylamide units and from 20% to 40% by weight of acrylic acid units.

In some embodiments, one or more acrylamide (co)polymers may have a weight average molecular weight (Mw) of greater than about 5,000,000 Dalton, or greater than about 10,000,000 Dalton, or greater than about 15,000,000 Dalton, or greater than about 20,000,000 Dalton, or greater than about 25,000,000 Dalton.

As used herein, the terms “polyacrylamide” or “PAM” generally refer to polymers and co-polymers comprising acrylamide moieties, and the terms encompass any polymers or copolymers comprising acrylamide moieties, e.g., one or more acrylamide (co)polymers. Furthermore, PAMs may comprise any of the polymers or copolymers discussed herein. Additionally, the PAMs described herein, e.g., one or more acrylamide (co)polymers, may be provided in one of various forms, including, for example, dry (powder) form (e.g., DPAM), water-in-oil emulsion (inverse emulsion), suspension, dispersion, or partly hydrolyzed (e.g., HPAM, in which some of the acrylamide units have been hydrolyzed to acrylic acid). In some embodiments, PAMs, e.g., one or more acrylamide (co)polymers, may be used for polymer flooding. In some embodiments, PAMS, e.g., one or more acrylamide (co)polymers, may be used in any EOR technique. In some embodiments, a polyacrylamide may be a cationic polyacrylamide (cPAM). In some embodiments, a cPAM may comprise a cationic copolymer of acrylamide or methacrylamide. In some embodiments, a cPAM may comprise a cationic copolymer of acrylamide or methacrylamide having an average molecular weight (MW) of between about 300 000-3 000 000 g/mol, between about 400 000-2 000 000 g/mol, between about, 500 000-1 500 000 g/mol, or between about 500 000-1 000 000 g/mol, for example. In some embodiments, a cPAM may comprise a cationic copolymer of acrylamide or methacrylamide that may be produced by copolymerizing acrylamide or methacrylamide with one or more cationic monomer(s). In some embodiments, said one or more cationic monomers may comprise any one or more of the cationic monomers discussed herein. In some embodiments, said one or more cationic monomers may include, but are not limited to including, methacryloyloxyethyltrimethyl ammonium chloride, acryloyloxyethyltrimethyl ammonium chloride (aka Q9), 3-(methacrylamido) propyltrimethyl ammonium chloride, 3-(acryloylamido) propyltrimethyl ammonium chloride, diallyldimethyl ammonium chloride (DADMAC), dimethylaminoethyl acrylate, dimethylaminoethyl methacrylate, dimethylaminopropylacrylamide, dimethylaminopropylmethacrylamide, and similar monomers. In some embodiments, a cPAM may comprise a copolymer of acrylamide or methacrylamide which further comprises (meth)acryloyloxyethyl-trimethyl ammonium chloride. In some embodiments, a cPAM may comprise one or more cationic monomers, such as those discussed herein, possessing a net charge that is cationic, and an acrylamide/methacrylamide backbone. In some embodiments, a cPAM may comprise an acrylamide or methacrylamide-based polymer that is treated after the polymerization to render it cationic or more cationic, for example, by using Hofmann or Mannich reactions. In some embodiments, a cPAM may comprise a cationic copolymer of acrylamide or methacrylamide that may be prepared by conventional radical-initiation polymerization methods. For example, polymerization may be performed by using solution polymerization in water, gel-like solution polymerization in water, aqueous dispersion polymerization, dispersion polymerization in an organic medium or emulsion polymerization in an organic medium. In some embodiments, a cPAM may comprise a cationic copolymer of acrylamide or methacrylamide that may be obtained either as an emulsion in an organic medium, aqueous dispersion, or as solution in water, or as a dry powder or dry granules after optional filtration and drying steps following the polymerization. In some embodiments, a cPAM may comprise a charge density of about 0.2-5 meq/g, about 0.3-4 meq/g, about 0.5-3 meq/g, or about 0.7-1.5 meq/g.

As used herein, the term “produced water” generally refers to any aqueous fluids produced during any type of industrial process, e.g., an oil or gas extraction or recovery process, or any portion thereof, such as but not limited to any enhanced oil recovery process or any portion thereof wherein the produced water comprises one or more polymers, e.g., one or more water-soluble polymers. Typically the produced water may be obtained during an industrial process involving the use of water, generally copious amounts of water, and the use of one or more water soluble polymers, e.g., viscosifying or thickening polymers, wherein the end product of such industrial process may be an aqueous material or “produced water” which may be of undesirable viscosity and/or purity because of the presence of an undesirable amount of said one or more water soluble polymers.

According to some embodiments, the produced water may be formed during any part of a process related to polymer flooding and may comprise any components and/or chemicals related to any part of said polymer flooding. This may be referred to as “polymer flooded produced water” or “polymer flooding produced water”, and the term produced water is to be understood to encompass any type of polymer flooded produced water or polymer flooding produced water. Produced water may be anoxic produced water. Produced water may be anaerobic produced water or may be aerobic produced water.

As used herein, the term “iron” generally refers to any form of iron, for example, iron of any isotopic state, iron of any oxidation state, any form of an iron compound, such as, for example, iron (III) chloride, iron (II) chloride (also known as ferrous chloride), iron (III) chloride hexahydrate, and iron sulfate. In some embodiments, iron may comprise iron (II).

As used herein, the term “aluminum” generally refers to any form of aluminum, for example, aluminum of any isotopic state, aluminum of any oxidation state, and/or any form of an aluminum compound, such as, for example polyaluminum chloride, aluminum sulfate, and aluminum oxide. In some embodiments, aluminum may comprise Al³⁺.

As used herein, the term “coagulant” generally may refer to an agent that may typically destabilize colloidal suspensions and/or may precipitate dissolved compounds. Coagulants may comprise aluminum-based coagulants, such as a polyaluminum chloride-based coagulants. Additional coagulants may comprise but are not limited to inorganic coagulants such as aluminium sulfate (“ALS”) and other metal sulfates; organic coagulants such as polyamines and polyDADMACs, cationic polyacrylamides (cPAMs) of various different molecular weights (MW) and charges; and other inorganic and organic coagulants known in the art.

Furthermore, a coagulant may comprise a poly(diallyldimethyl ammonium chloride) (“polyDADMAC”) compound; one or more cPAM compounds; an epi-polyamine compound; a polymer that comprising one or more quaternized ammonium groups, such as acryloyloxyethyltrimethylammonium chloride, methacryloyloxyethyltrimethylammonium chloride, methacrylamidopropyltrimethylammonium chloride, acrylamidopropyltrimethylammonium chloride; or a mixture of any of the foregoing. An inorganic coagulant may, for example, reduce, neutralize or invert electrical repulsions between particles. Inorganic coagulants may comprise but are not limited to inorganic salts such as aluminum chloride, aluminum sulfate, aluminum chlorohydrate, polyaluminum chloride, polyaluminum silica sulfate, ferric chloride, ferrous chloride, ferric sulfate, ferric chloride sulfate, polyferric sulfate, ferrous sulfate, lime, calcium chloride, calcium sulfate, magnesium chloride, sodium aluminate, various commercially available iron or aluminum salts coagulants, or combinations thereof. In some embodiments, a coagulant may comprise a combination or mixture of one or more organic coagulants with one or more inorganic coagulants. In some embodiments, a coagulant may comprise a combination or mixture of any of the above coagulants.

As used herein, the term “sludge” generally refers to a mixture of liquid and solid components, which may be viscous or non-viscous, and which may comprise oil, water, and/or sediment. In some embodiments, produced water may comprise sludge. In some embodiments, produced water comprising sludge may result from enhanced oil recovery.

As used herein, the term “effluent” generally refers to treated or untreated wastewater that may be discharged from a treatment plant, sewer, or industrial outfall. Sometimes, effluent may refer to wastes discharged into surface waters. Effluent may generally refer to treated or untreated produced water, i.e., produced water resulting from one or more processes related to enhanced oil recovery.

As used herein, the terms “sulfonated polyacrylamide” or “sulfonated PAM” generally refer to polyacrylamide polymers or PAMs as above-defined which comprise one or more sulfonic acid moieties, e.g., one or more sulfonic acid monomers. Examples thereof include acrylamide tertiary butyl sulfonic acid (also known as 2-acrylamido-2-methylpropane sulfonic acid or N-t-butyl acrylamide sulfonic acid) (“ATBS”); vinylsulfonic acid; 4-styrenesulfonic acid; and salts of any of these moieties/monomers.

As used herein, the term “polyaluminum chloride-based coagulant” (“PACl-based coagulant”) generally refers to a coagulant comprising aluminum and chloride. In some instances, polyaluminum chloride comprised by said PACl-based coagulant may be characterized by its strength, which may generally be expressed in percent alumina, or Al₂O₃, and its basicity. In some instances a PACl-based coagulant may be pre-neutralized and may have a higher charge density as compared to other coagulants that may generally be used to effect coagulation. In some embodiments, one or more PACl-based coagulants may be provided in liquid form. In some embodiments, one or more PACl-based coagulants may be provided in dry (powder) form. In some embodiments, one or more PACl-based coagulants may be modified with one or more polyamine-based polymers, e.g., modified with one or more polyDADMAC-based polymers. In some embodiments, one or more PACl-based coagulants may be modified with one or more cPAMs. In some embodiments, one or more PACl-based coagulants may be modified with one or more cPAMs and/or one or more polyamine-based polymers. In some embodiments, one or more PACl-based coagulants may be modified with at least two polyamine-based polymers. In some embodiments, one or more PACl-based coagulants may be modified with one or more polyDADMACs and/or one or more cPAMs. In some embodiments, one or more PACl-based coagulants may be modified with one or more polyDADMACs and/or one or more polyamine-based polymers and/or one or more cPAMs. In some embodiments, one or more PACl-based coagulants may comprise 25%-45% basicity (i.e., OH/A1 ratio of about 0.75 to about 1.35). In some embodiments, one or more PACl-based coagulants may comprise up to about 70% basicity (i.e., an OH/A1 ratio of about 2.10). In some embodiments, one or more PACl-based coagulants for use in the methods and compositions described herein may comprise from about 0.1% or less to about 85% or more basicity (e.g., an OH/A1 ratio of about 2.55) or more. In some embodiments, one or more PACl-based coagulants for use in the methods and compositions described herein may comprise 0% basicity. In some embodiments, one or more PACl-based coagulants may be optimized for particle removal by controlling the formation of Al species in the products. In some embodiments, one or more PACl-based coagulants may comprise from about 0.1% or less to about 15% or more aluminum. In some embodiments, one or more PACl-based coagulants may comprise about 17% Al₂O₃.

### Methods and Compositions

Disclosed herein are methods and compositions for the treatment of produced water, such as produced water resulting from any part of an EOR process, such as a polymer flood, comprising one or more water-soluble polymers, typically high molecular weight water soluble polymers which are conventionally used in oil or gas extraction or recovery processes, such as enhanced oil recovery processes. In some embodiments, a method for treating produced water comprising one or more water soluble polymers may comprise treating the produced water with one or more PACl-based coagulants. In some embodiments, the one or more PACl-based coagulants may comprise one or more PACl-based coagulants modified with one or more polyamine-based polymers. In some embodiments, the one or more PACl-based coagulants may comprise one or more PACl-based coagulants modified with at least two polyamine-based polymers. In some embodiments, the one or more PACl-based coagulants may comprise one or more PACl-based coagulants modified with one or more polyDADMACs. In some embodiments, the one or more PACl-based coagulants may comprise one or more PACl-based coagulants modified with one or more polyDADMACs and/or one or more polyamine-based polymers. In some embodiments, the one or more PACl-based coagulants may comprise one or more PACl-based coagulants modified with one or more cPAMs. In some embodiments, the one or more PACl-based coagulants may comprise one or more PACl-based coagulants modified with one or more cPAMs and/or one or more polyamine-based polymers. In some embodiments, the one or more PACl-based coagulants may comprise one or more PACl-based coagulants modified with one or more polyDADMACs and/or one or more cPAMs. In some embodiments, the one or more PACl-based coagulants may comprise one or more PACl-based coagulants modified with one or more polyDADMACs and/or one or more cPAMs and/or one or more polyamine-based polymers. In some embodiments, a polyamine-based polymer may comprise polymers which result from the reaction of epichlorohydrin and dimethylamine. In some embodiments, polyamine-based polymers may comprise branched polyamine polymers which result from the reaction of epichlorohydrin, dimethylamine, and diethylenetriamine (DETA). In some embodiments, a polyamine-based polymer may comprise any one or more of polyethyleneimines, poly-(dimethylamine(co)epichlorohydrin), poly(dimethylamine-co-epichlorohydrin-co-ethylenediamine, or combinations thereof. In some embodiments, a polyamine-based polymer may comprise poly(epichlorohydrin-co-bis(hexamethylene)triamine). In some embodiments, a polyamine-based polymer may comprise hydrolyzed poly-N-vinylformamides (sometimes referred to as polyvinylamines) and/or polyamidoamines. In some embodiments, a polyacrylamide may be a cationic polyacrylamide (cPAM). In some embodiments, a cPAM may comprise a cationic copolymer of acrylamide or methacrylamide. In some embodiments, a cPAM may comprise a cationic copolymer of acrylamide or methacrylamide having an average molecular weight (MW) of between about 300,000-3,000 000 g/mol, between about 400,000-2,000,000 g/mol, between about, 500,000-1,500,000 g/mol, or between about 500,000-1,000,000 g/mol, for example. In some embodiments, a cPAM may comprise a cationic copolymer of acrylamide or methacrylamide that may be produced by copolymerizing acrylamide or methacrylamide with one or more cationic monomer(s). In some embodiments, said one or more cationic monomers may comprise any one or more of the cationic monomers discussed herein. In some embodiments, said one or more cationic monomers may include, but are not limited to including, me thacryloyloxyethyltrimethyl ammonium chloride, acryloyloxyethyltrimethyl ammonium chloride (aka Q9), 3-(methacrylamido) propyltrimethyl ammonium chloride, 3-(acryloylamido) propyltrimethyl ammonium chloride, diallyldimethyl ammonium chloride (DADMAC), dimethylaminoethyl acrylate, dimethylaminoethyl methacrylate, dimethylaminopropylacrylamide, dimethylaminopropylmethacrylamide, and similar monomers. In some embodiments, a cPAM may comprise a copolymer of acrylamide or methacrylamide and (meth)acryloyloxyethyl-trimethyl ammonium chloride. In some embodiments, a cPAM may comprise one or more cationic monomers, such as those discussed herein, a net charge that is cationic, and an acrylamide/methacrylamide backbone. In some embodiments, a cPAM may comprise an acrylamide or methacrylamide based polymer that is treated after the polymerization to render it cationic, for example, by using Hofmann or Mannich reactions. In some embodiments, a cPAM may comprise a cationic copolymer of acrylamide or methacrylamide that may be prepared by conventional radical-initiation polymerization methods. For example, polymerization may be performed by using solution polymerization in water, gel-like solution polymerization in water, aqueous dispersion polymerization, dispersion polymerization in an organic medium or emulsion polymerization in an organic medium. In some embodiments, a cPAM may comprise a cationic copolymer of acrylamide or methacrylamide that may be obtained either as an emulsion in an organic medium, aqueous dispersion, or as solution in water, or as a dry powder or dry granules after optional filtration and drying steps following the polymerization. In some embodiments, a cPAM may comprise a charge density of about 0.2-5 meq/g, about 0.3-4 meq/g, about 0.5-3 meq/g, or about 0.7-1.5 meq/gln some embodiments, the resultant treated water may be recycled and reused in other industrial processes including e.g., other oil recovery processes, or it may be released into the environment. In some embodiments, the amount of the one or more PACl-based coagulants added to effect treatment may be an amount that is effective to reduce the viscosity of the produced water; result in less sticky, floating floc; reduce the TOC of said produced water; increase the COD removal rate from the produced water; reduce the oil concentration of the produced water; affect salinity in a desired manner; affect zeta potential in a desired manner; affect the charge of the produced water in a desirable manner, i.e., the absolute charge may be reduced; the alkalinity may be altered; zeta potential/salinity may be affected; the sludge volume may decrease; sludge density may increase; sludge dryness may increase; sludge dewatering may increase; the rate of floc formation may increase; oil removal may be enhanced; the settling rate may increase; the amount of micro floc may be reduced; the amount of polymer removed from produced water may increase; dewatering efficiency may increase, and the like, as compared to other coagulants; or any combination of the foregoing. In some embodiments, the amount of said one or more PACl-based coagulants used to treat said produced water may be an amount that is effective to reduce the viscosity of the produced water and/or to remove one or more polymers from the produced water. In some embodiments, treatment of the produced water with one or more PACl-based coagulants may result in reduction of the amount of the one or more polymers comprised in the produced water by about 50% or less, by about 50% or more, by about 55% or more, by about 60% or more, by about 65% or more, by about 70% or more, by about 75% or more, by about 80% or more, by about 85%, or more by about 90% or more, by about 95% or more, or by about 98% or more as compared to untreated produced water. The reduction in the amount of the polymers may be measured by any one or more of various means, such as, for example, by TOC, detection of residual of polymer, zeta potential, and/or charge. In some embodiments, treatment of the produced water with one or more PACl-based coagulants may result in a reduction of the viscosity of the produced water by about 10% or less, about 10% or more, about 15% or more, about 20% or more, about 25% or more, about 30% or more, about 35% or more, about 40% or more, about 45% or more, about 50% or more, about 55% or more, about 60% or more, about 65% or more, about 70% or more, about 75% or more, about 80% or more, about 85% or more, about 90% or more, about 95% or more, or about 98% or more as compared to untreated produced water.

According to some embodiments treatment of the produced water may reduce the viscosity to a level that is beneficial for reinjection, reuse, or (environmentally acceptable) disposal purposes. In some embodiments, treatment of the produced water according to the methods described herein may result in a treated produced water that may be reused in the same or other industrial processes such as EOR processes, or it may be released into the environment. In some embodiments, produced water which has been treated in accordance with the methods described herein may be reused for polymer injection, backflow water application, and/or water injection. In some embodiments, treating produced water according to the methods described herein may result in treated produced water that may be used more efficiently in skim tank settling as compared to the untreated produced water and/or the produced water treated by other processes conventionally used in the industry. In some embodiments, the treated produced water resulting from the methods disclosed herein may be recycled to one or more oil recovery processes, such as an EOR process.

In some embodiments, use of the methods and compositions herein to treat effluent may improve effluent quality. In some embodiments, improvement in effluent quality may comprise any one or more of the following: reduction in the concentration of polymer present in said effluent, e.g., concentration of one or more water soluble polymers; reduced oil concentration; reduced sludge volume; reduced solid concentration, e.g., reduced particulate, suspended, and/or collodial solid concentration; or improved sludge dewatering. In some embodiments, use of the methods and compositions described herein to treat effluent may allow the treated effluent to be reinjected and/or discharged into the environment.

In some embodiments, the sludge volume that may result from produced water treated by methods and/or compositions comprising use of one or more PACl-based coagulants may be from about 10% to about 30% of the total volume before a dewatering and/or separation step. In some embodiments, a method of treating produced water with one or more PACl-based coagulants may be effected through a single treatment with said one or more PACl-based coagulants. In some embodiments, a method of treating produced water with one or more PACl-based coagulants may be effected through more than one treatment with one or more PACl-based coagulants.

According to some embodiments, the produced water which is treated results from a polymer flood process. In some embodiments, the produced water comprises one or more water-soluble polymers, such as, for example, one or more water soluble, high molecular weight anionic polyacrylamide-based polymers. In some embodiments, the produced water comprises one or more acrylamide-containing (co)polymers and/or one or more polymers comprising monomers of acrylamide and acrylic acid and/or one or more sulfonated polymers, e.g., one or more sulfonated PAMs.

In some embodiments the amount of the one or more PACl-based coagulants used to treat the produced water comprises any amount that achieves a desired effect, generally reduction of viscosity of the treated produced water and/or removal of water soluble polymers comprised therein. For example, the amount added may comprise an amount that achieves a desired reduction in viscosity of the produced water that is to be or is treated or a desired amount or degree of removal of water soluble polymers comprised therein. The dosage of the one or more PACl-based coagulants may vary, for example, at least in part based upon the quality of the produced water, the components of the produced water, the concentration of the polymer in the produced water, the type of polymer in the produced water, and/or the treatment process, as well as the desired result.

In some embodiments, a method of treating produced water with one or more PACl-based coagulants may result in about 0.02 gram or less, about 0.02 gram or more, about 0.04 gram or more, about 0.06 gram or more, about 0.08 gram or more, about 0.10 gram or more, about 0.12 gram or more, about 0.14 gram or more, or about 0.16 gram more of polymer removed per mMol of Al comprised by said one or more PACl-based coagulants. In some embodiments, a method of treating produced water with one or more PACl-based coagulants may result in removal of about 40% or less, about 40% or more, about 50% or more, about 60% or more, about 70% or more, about 80% or more, about 90% or more, about 95% or more, about 96% or more, about 97% or more, about 98% or more, or about 99% or more of one or more polymers that may be comprised by said produced water, e.g., one or more water soluble polymers.

In some embodiments, one or more PACl-based coagulants for use in the methods and compositions described herein may comprise 25%-45% basicity (i.e., OH/A1 ratio of about 0.75 to about 1.35). In some embodiments, one or more PACl-based coagulants for use in the methods and compositions described herein may comprise up to about 70% basicity (e.g., an OH/A1 ratio of about 2.10). In some embodiments, one or more PACl-based coagulants for use in the methods and compositions described herein may comprise from about 0.1% or less to about 85% or more basicity (e.g., an OH/A1 ratio of about 2.55) or more. In some embodiments, one or more PACl-based coagulants for use in the methods and compositions described herein may comprise 0% basicity. In some embodiments, one or more PACl-based coagulants for use in the methods and compositions described herein may be optimized for particle removal by controlling the formation of Al species in the products. In some embodiments, one or more PACl-based coagulants for use in the methods and compositions described herein may comprise from about 0.1% or less to about 15% or more aluminum. In some embodiments, one or more PACl-based coagulants for use in the methods and compositions described herein may comprise about 17% Al₂O₃.

In some embodiments, use of compositions comprising one or more PACl-based coagulants in methods for the treatment of produced water may result in any one or more of the following: less pH depression and/or alkalinity depletion, which may thereby reduce lime or caustic requirements; reduced sludge volumes; increased sludge density; improved results in higher pH system as compared to other coagulants; minimized pH adjustment; improved filter operation; and/or improved performance in cold water as compared to other coagulants and/or untreated produced water. In some embodiments, the produced water to be treated may be about 30° C. or less, 40° C. or less, 50° C. or less, 60° C. or less, 70° C. or less, or 70° C. or more.

In some embodiments, a method of treating produced water with one or more PACl-based coagulants may be effected prior to skim tank settling. In some embodiments, produced water to be treated according to the methods and/or with the compositions described herein may comprise one or more water soluble polymers. In some instances, said one or more water soluble polymers may comprise one or more high molecular weight polymers. In some embodiments, said one or more water soluble polymers may comprise one or more anionically charged high molecular weight polymers. In some embodiments, produced water treated with by the methods and/or with the compositions described herein may result in a treated produced water which may meet desired effluent quality standards. For example, the treated produced water may be of sufficient effluent quality for discharge or reinjection or other desired purposes.

In some embodiments, methods for the treatment of produced water using one or more PACl-based coagulants comprises mixing of the one or more PACl-based coagulants with the produced water. In general the type of mixing used includes any type conventionally used in industrial processes, such as EOR processes, that produce a necessary or desired effect. In some embodiments, mixing may be conducted using a mixing apparatus, which may be a mixing tank with a mixer, a horizontal mixer, or a screw mixer. The mixing tank typically may be equipped with a blade mixer. In some embodiments, mixing may occur inside of a pipe, e.g., one that comprises said one or more PACl-based coagulants and produced water, such as due to flow turbulency that may be caused by the pump or the use of a static mixer. In some embodiments, magnetic stirring may be used for mixing. In some embodiments, an overhead mixer may be used for mixing.

In some embodiments, the method for the treatment of produced water using one or more PACl-based coagulants may be conducted on-site, e.g., at any onshore oil field, at any offshore oil field, at a treatment facility, at a disposal well, or at any other location where produced water is present.

In some embodiments, an increased dosage of one or more PACl-based coagulants used in methods of treating the produced water may result in a corresponding decrease in the viscosity of said produced water. In some embodiments, an increased dosage of PACl-based coagulants used in methods for the treatment of produced water may result in a corresponding increase in the removal of the one or more polymers.

In some embodiments, methods to treat produced water using one or more PACl-based coagulants may comprise treating said produced water with 100 ppm or less, 100 ppm or more, 150 ppm or more, 200 ppm or more, 250 ppm or more, 300 ppm or more, 350 ppm or more, 400 ppm or more, 450 ppm or more, 500 ppm or more, 600 ppm or more, 700 ppm or more, or 800 ppm or more of said one or more PACl-based coagulants. In some embodiments, the PACl-based coagulant may comprise 5 ppm or less, 5 ppm or more, 10 ppm or more, 15 ppm or more, 20 ppm or more, 25 ppm or more, 30 ppm or more, 35 ppm or more, 40 ppm or more, 45 ppm or more, 50 ppm or more, 60 ppm or more, 70 ppm or more, 80 ppm or more, 90 ppm or more, 100 ppm or more, 150 ppm or more, 200 ppm or more, 250 ppm or more, 300 ppm or more, 350 ppm or more, 400 ppm or more, 450 ppm or more, 500 ppm or more, 600 ppm or more, 700 ppm or more, or 800 ppm or more of any one or more components of the PACl-based coagulant, such as, for example, the one or more polyamines and/or polyaluminum chloride and/or cPAMs.

In some embodiments, methods to treat produced water using one or more PACl-based coagulants may be effective over a wide range of pH values. For instance, treatment may be effective from a pH range of about 2.0 to about 10.0, about 3.0 to about 9.0, about 4.0 to about 9.0, about 5.0 to about 8.0, and/or about 6.0 to about 8.0.

In some embodiments, methods to treat produced water using one or more PACl-based coagulants may be used alone, e.g., consist of this treatment method, or this treatment method may be used in combination with one or more additional processes, e.g., those conventionally used in the industry to treat produced water. Other processes for produced water treatment include, for example, mechanical treatments (e.g., membrane filtration), chemical treatments (e.g., oxidizing agents), and biological treatments (e.g., microbiological processes).

In some embodiments, methods of treating produced water using one or more PACl-based coagulants may result in a COD removal rate of about 50% or less, 50% or more, 60% or more, 70% or more, 80% or more, or 91% or more. In some embodiments, methods of treating produced water using one or more PACl-based coagulants may decrease the viscosity by about 10% or less, 10% or more, 20% or more, 30% or more, 40% or more, or 50% or more as compared to untreated produced water.

In some embodiments, methods of treating produced water using one or more PACl-based coagulants may comprise treatment under anaerobic conditions. In some embodiments, methods of treating produced water using one or more PACl-based coagulants may comprise treatment under aerobic conditions. In some embodiments, methods of treating produced water using one or more PACl-based coagulants, e.g., one or more PACl-based coagulants that comprise PACl, one or more polyamine-based polymers, and one or more cPAMs, may comprise the separate addition of these compounds to produced water or these compounds may be combined in one or more compositions containing these compounds which compositions are then used to treat produced water. For example the addition of separate doses of the different compounds, i.e., one or more PACl-based coagulants may comprise treatment under aerobic conditions. In some embodiments, methods of treating produced water using one or more PACl-based coagulants, e.g., one or more PACl-based coagulants that comprise PACl, one or more polyamine-based polymers, and one or more cPAMs, may be desirable if the final composition does not possess desired or optimal properties, e.g., adequate stability over a specific time period. More specifically, in some embodiments, methods of treating produced water may comprise using one or more PACl-based coagulants, e.g., one or more PACl-based coagulants that comprise PACl, one or more polyamine-based polymers, and one or more cPAMs, may comprise addition of PACl, one or more polyamine-based polymers, and one or more cPAMs simultaneously, e.g., as a mixture, may be added separately, and/or may be added multiple times. Separate addition of PACl, one or more polyamine-based polymers, and one or more cPAMs may occur in any order, and may occur in combinations, i.e., addition of one polyamine-based polymer and one cPAM occur first, followed by addition of PACl, followed by addition of a second polyamine-based polymer and a second cPAM. In some embodiments, methods of treating produced water using one or more PACl-based coagulants, e.g., one or more PACl-based coagulants that comprise PACl, one or more polyamine-based polymers, and one or more cPAMs, may comprise addition of PACl, one or more polyamine-based polymers, and one or more cPAMs in one or more doses as needed or in intervals, in a stepwise fashion, or in a continuous fashion.

In some embodiments, methods of treating produced water using one or more PACl-based coagulants, e.g., one or more PACl-based coagulants that comprise PACl, one or more polyamine-based polymers, and one or more cPAMs, may comprise treatment under anaerobic or aerobic conditions and may result in removal of about 10% or less, 10% or more, 20% or more, 30% or more, 40% or more, 50% or more, 60% or more, or about 70% or more of polymers whose removal is desired. In some embodiments, methods of treating produced water using one or more PACl-based coagulants, e.g., one or more PACl-based coagulants that comprise PACl, one or more polyamine-based polymers, and one or more cPAMs, may comprise treatment under anaerobic or aerobic conditions and may result in a COD removal rate of about 10% or less, 10% or more, 15% or more, 20% or more, 25% or more, 30% or more, 35% or more, 40% or more, or 45% or more. In some embodiments, methods of treating produced water using one or more PACl-based coagulants, e.g., one or more PACl-based coagulants that comprise PACl, one or more polyamine-based polymers, and one or more cPAMs, may comprise treatment under anaerobic or aerobic conditions and may result in a polymer removal rate of about 10% or less, 10% or more, 20% or more, 30% or more, 40% or more, 50% or more, 60% or more, 70% or more, or about 78% or more. In some embodiments, methods of treating produced water using one or more PACl-based coagulants, e.g., one or more PACl-based coagulants that comprise PACl, one or more polyamine-based polymers, and one or more cPAMs, may comprise treatment under anaerobic or aerobic conditions and may result in an oil removal rate of about 10% or less, 10% or more, 20% or more, 30% or more, 40% or more, 50% or more, 60% or more, 70% or more, or about 80% or more.

Furthermore, the present disclosure generally relates to a composition suitable for use in treating produced water, comprising one or more PACl-based coagulants, one or more water soluble polymers, and produced water. In some embodiments, said composition may comprise one or more PACl-based coagulants modified with one or more polyamine-based polymers. In some embodiments, said composition may comprise one or more PACl-based coagulants modified with at least two polyamine-based polymers. In some embodiments, the one or more PACl-based coagulants may comprise one or more PACl-based coagulants modified with one or more polyDADMACs. In some embodiments, the one or more PACl-based coagulants may comprise one or more PACl-based coagulants modified with one or more polyDADMACs and/or one or more polyamine-based polymers. In some embodiments, the one or more PACl-based coagulants may comprise one or more PACl-based coagulants modified with one or more cPAMs. In some embodiments, the one or more PACl-based coagulants may comprise one or more PACl-based coagulants modified with one or more cPAMs and/or one or more polyamine-based polymers. In some embodiments, the one or more PACl-based coagulants may comprise one or more PACl-based coagulants modified with one or more polyDADMACs and/or one or more cPAMs. In some embodiments, the one or more PACl-based coagulants may comprise one or more PACl-based coagulants modified with one or more polyDADMACs and/or one or more cPAMs and/or one or more polyamine-based polymers. In some embodiments, the produced water of the compositions described herein may comprise one or more PAMs, e.g., any polymers or co-polymers comprising acrylamide moieties, e.g., one or more acrylamide (co)polymers, e.g., one or more polymers comprising acrylamide and acrylic acid, e.g., one or more sulfonated polymers, such as one or more sulfonated PAMs. Said one or more PAMs may comprise one or more HPAMs and/or one or more DPAMs. In some embodiments, the produced water of the compositions discussed herein may comprise one or more water soluble, high molecular weight anionic polyacrylamide-based polymers. In some embodiments, the compositions described herein, e.g., a composition suitable for use in treating produced water, comprising one or more PACl-based coagulants, one or more water soluble polymers, and produced water, may be used with any of the methods of treatment of produced water described herein. Such PACl-based coagulants may include those which are commercially available. In some embodiments, said composition may comprise one or more PACl-based coagulants which may comprise 25%-45% basicity (i.e., OH/A1 ratio of about 0.75 to about 1.35). In some embodiments, said composition may comprise one or more PACl-based coagulants which may comprise up to about 70% basicity (i.e., an OH/A1 ratio of about 2.10). In some embodiments, one or more PACl-based coagulants for use in the methods and compositions described herein may comprise from about 0.1% or less to about 85% or more basicity (e.g., an OH/A1 ratio of about 2.55) or more. In some embodiments, one or more PACl-based coagulants for use in the methods and compositions described herein may comprise 0% basicity. In some embodiments, said composition may comprise one or more PACl-based coagulants which may be optimized for particle removal by controlling the formation of Al species in the products. In some embodiments, said composition may comprise one or more PACl-based coagulants which may comprise from about 0.1% or less to about 15% or more aluminum. In some embodiments, said composition may comprise one or more PACl-based coagulants which may comprise about 17% Al₂O₃.

### EXAMPLES

### Example 1—Produced Water Treatment

In this example, a simulated produced water sample that comprised a commercially available water soluble, high molecular weight anionic polyacrylamide-based polymer (Polymer A) and synthetic brine was prepared and treated. Standard jar test equipment was used, and analysis of reference and treated samples were performed, wherein viscosity, TOC, zeta potential, floc strength, settling, and sludge volume of the reference (untreated) sample and treated samples were measured. For viscosity and zeta potential measurements, samples were filtered through a 45 μm sieve. Zeta potential was measured by using a Malvern Zeta sizer. For TOC measurements, samples were filtered through an 0.45 μm filter, and measurement were performed using an LC-OCD analyzer. For floc strength measurements, shear floc was evaluated with high mixing speed. For settling measurements, settling time was measured during settling. For sludge volume measurements, sludge volume was measured after treatment (in the case of treated samples) in a graduated cylinder. For viscosity measurements, viscosity was measured with a Brookfield ULA sensor at 60 rpm at room temperature.

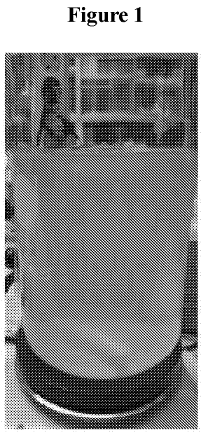

Samples were prepared as follows. First, stock polymer solution at 5,000 ppm polymer (Polymer A) was prepared by dissolving polymer in brine and mixing overnight. Next, an amount of polymer stock solution was added to brine that resulted in a polymer solution in brine containing 400 ppm polymer (FIG. 1). Following preparation of this polymer solution, polymer was sheared for 30 min. by a centrifuge pump. After shearing, 500 ppm of oil was added to the polymer solution while mixing the solution at 2,000 RPM.

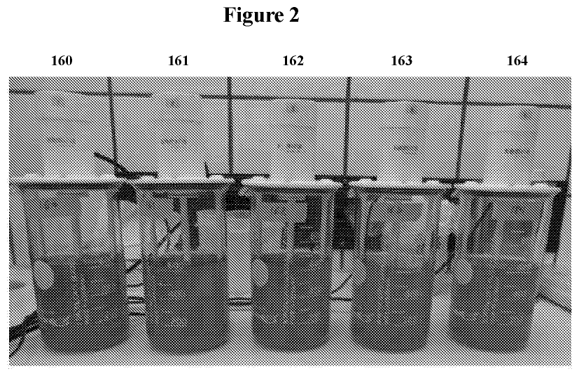

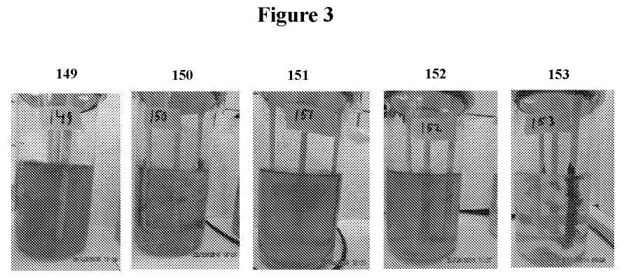

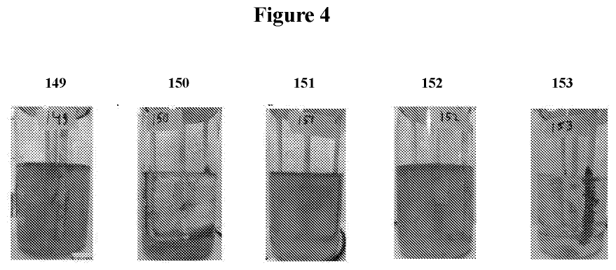

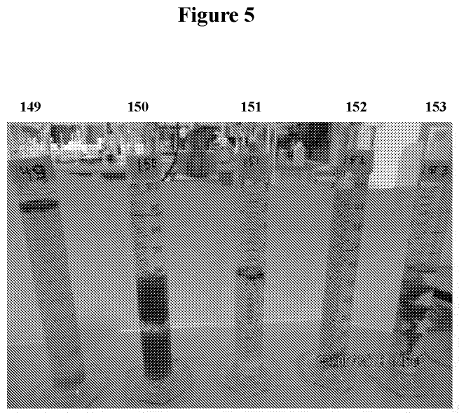

Tests to analyze the viscosity, TOC, zeta potential, floc strength, settling, and sludge volume were then performed on both untreated (reference) and treated samples (Trial 1), wherein treated samples were treated using PACl-based coagulants or a combination of two different polyamine-based polymers, wherein some of said PACl-based coagulants were modified with one or two of said two different polyamine-based polymers in addition to comprising an inorganic coagulant (polyaluminum chloride) (see Table 1). An image of samples 160-164 which comprised polymer and oil mixtures was taken prior to treatment with said PACl-based coagulants (FIG. 2). PACl-based coagulants were then added to polymer samples prepared as described above with slow mixing in order to compare the performance of PACl-based coagulants and two different polyamine-based polymers. Photos were taken during the addition of said PACl-based coagulants during slow mixing. FIG. 3 presents an image of samples 149-153 that was taken during this step of treatment. The composition of each PACl-based coagulant used for each of samples 149, 150, 151, 152, and 153, as pictured in FIG. 3, FIG. 4, and FIG. 5, is detailed in Table 1 below. As presented in FIG. 3, floc size and shapes varied between each of the pictured treated samples.

After the treatment procedure, samples were allowed to settle, and images of each sample were taken (FIG. 4). Next, sludge volume measurements were taken for each of the samples (FIG. 5).

TABLE 1
TRIAL 1

| | PACl COMPOSITION | | | |
|---|---|---|---|---|
| | Polyamine- | Polyamine- | | |
| Sample | based | based | Inorganic | pH of |
| No. | Polymer 1 | Polymer 2 | Coagulant | Solution |
| 149 | High | Minimum | Minimum | 6.0 |
| 150 | High | Minimum | High | 8.4 |
| | | | (maximum | |
| | | | concentration) | |
| 151 | High | High | Zero | 6.0 |
| 152 | High | High | Zero | 8.4 |
| 153 | High | High | Medium | 7.2 |

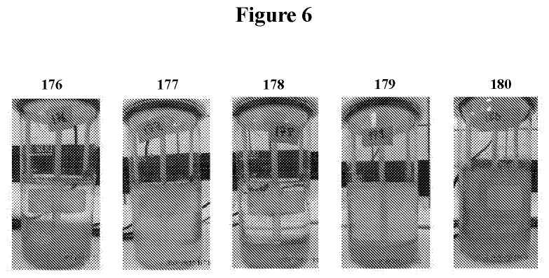

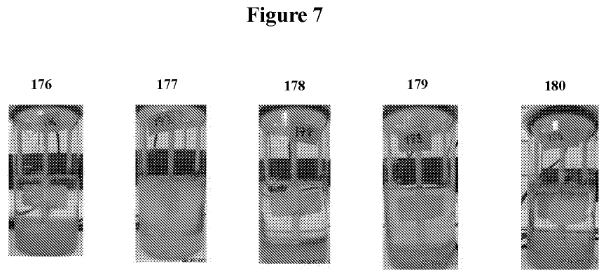

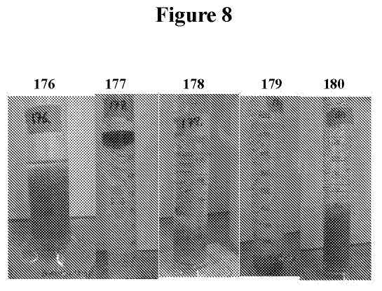

Further tests to analyze the viscosity, TOC, zeta potential, floc strength, settling, and sludge volume were then performed on both untreated (reference) and treated samples (Trial 2), wherein treated samples were treated using PACl-based coagulants or a combination of two different polyamine-based polymers, wherein some of said PACl-based coagulants were modified with one or two of said two different polyamine-based polymers in addition to comprising an inorganic coagulant (polyaluminum chloride) (see Table 2). PACl-based coagulants were added with slow mixing to polymer samples prepared as described above in order to compare the performance of PACl-based coagulants of different compositions and two different polyamine-based polymers. Photos were taken during the addition of said PACl-based coagulants to samples 176-180 during slow mixing (FIG. 6). The composition of each PACl-based coagulant used for each of samples 176, 177, 178, 179, and 180, as pictured in FIG. 6 FIG. 7, and FIG. 8, is detailed in Table 2 below. As presented in FIG. 6, floc size and shapes varied between each of the pictured treated samples.

After the treatment procedure, samples were allowed to settle, and images of each sample were taken (FIG. 7). Next, sludge volume measurements were taken for each of the samples (FIG. 8).

TABLE 2
TRIAL 2

| | PACl COMPOSITION | | | |
|---|---|---|---|---|
| | Polyamine- | Polyamine- | | |
| Sample | based | based | Inorganic | pH of |
| No. | Polymer 1 | Polymer 2 | Coagulant | Solution |
| 176 | High | Minimum | Maximum | 7.60 |
| 177 | High | Medium | Minimum | 6.00 |
| 178 | High | Medium | Medium | 6.75 |
| 179 | High | High | Minimum | 7.50 |
| 180 | High | High | Medium | 6.00 |

The results of Trial 1 and Trial 2 demonstrated the utility of PACl-based coagulants comprising polyaluminum chloride modified with one or two different polyamine-based polymers. The results demonstrated a significant reduction in TOC and decreased viscosity in samples treated with said PACl-based coagulants comprising polyaluminum chloride modified with one or two different polyamine-based polymers as TOC and viscosity were reduced by an average of about 90% to about 98%. Furthermore, samples treated with PACl-based coagulants comprising polyaluminum chloride modified with one or two different polyamine-based polymers demonstrated desired floc properties, as the flocs formed rapidly (sometimes less than a minute during fast mixing); flocs were shear resistant; and the sludge volume was low and varied from 10% to about 30% of the total volume before the dewatering/separation step when treated with said PACl-based coagulants. The results further demonstrated that in some instances a single treatment with a polymer modified PACl-based coagulant resulted in desired effluent qualities.

### Example 2—Produced Water Treatment

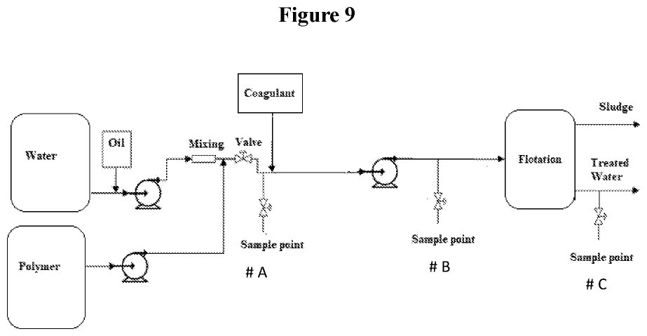

Larger scale tests were performed to assess the performance of various different PACl-based coagulants, wherein some of said PACl-based coagulants were modified with one or two different polyamine-based polymers. The flow diagram of the test flow loop used for the field trial experiments is presented in FIG. 9. Various analyses related to polymer concentration in the produced water samples were performed. Analysis methods used in the present example for measuring residual of polymer included KemConnect EOR (Kemira) and, Size Exclusion Chromatography (SEC). Analyses performed on the samples included viscosity measurements for all samples; visual evaluation of floc size and sludge volume; total organic carbon (TOC) measurements for selected samples; chemical oxygen demand (COD) measurements for selected samples; oil concentration measurements including analyses of oil concentration from selected samples; and dryness of sludge measurements.

The composition of samples used for the present example is detailed in Table 3 below (see Table 3).

TABLE 3

| | HPAM | Oil | | |
|---|---|---|---|---|
| Sample | concentration, | concentration, | Product and | TDS, |
| name | ppm | ppm | dosage | % |
| 1B | 100 | 0 | Formulation 1, | 0.5 |
| duplicate | | | 200 ppm | |
| 2B | 100 | 0 | PACl, 525 ppm | 0.5 |
| 3B | 200 | 0 | PACl, 700 ppm | 0.5 |
| 4B | 200 | 0 | PACl, 460 ppm | 0.5 |
| 5B | 200 | 260 | Formulation 1, | 0.5 |
| | | | 467 ppm | |
| 6B | 200 | 260 | PACl, 460 ppm | 0.5 |
| 7B | 100 | 260 | Formulation 1, | 0.5 |
| | | | 296 ppm | |
| 8B | 200 | 260 | Formulation 1, | 3.5 |
| | | | 452 ppm | |

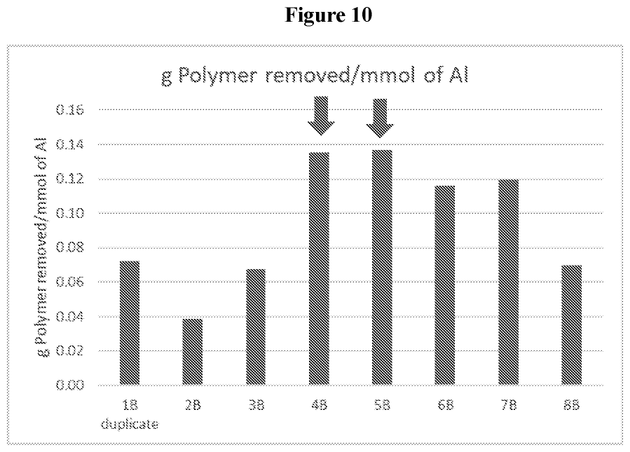

The efficiency of polymer removal was assessed in various samples using various different compositions (FIG. 10). Referring to the graph presented in FIG. 10, the amount of polymer (grams) removed per mMol of aluminum comprised by said PACl-based coagulants is presented. As shown in FIG. 10, compositions marked with an arrow demonstrated a high degree of polymer removal efficiency per mmol of Al in the PACl-based coagulant. At 467 ppm dose of the PACl-based coagulant modified with polyamine-based polymers Sample 5B the highest degree of polymer removal efficiency was observed for the tests as presented by FIG. 10, that is, the highest amount of polymer was removed per mmol of Al of Sample 5B added to the sample.

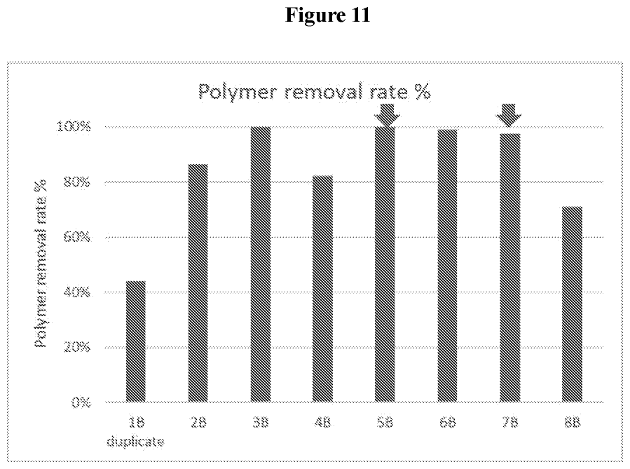

Referring now to FIG. 11, the data of FIG. 10 was replotted to present the results obtained as percent of polymer removed by the compositions of Table 3. FIG. 11 shows that several compositions were able to remove between about 40% to about 100% of polymer from a sample. As presented in FIG. 11, several compositions, some of which comprised a PACl-based coagulant modified with polyamine-based polymers, were able to remove nearly 100% of the polymer present in one of the samples (FIG. 11, indicated by arrows).

For some of the samples of the present example, the COD removal rate was measured (see Table 4). As presented in Table 4, several compositions, some of which comprise a PACl-based coagulant modified with polyamine-based polymers, demonstrated a COD removal rate of higher than about 50%, and the maximum COD removal rate was about 91% (see Table 4).

TABLE 4

| Sample | COD |
|---|---|
| name | removal |
| 1B duplicate | 55% |
| 2B | 78% |
| 3B | 91% |
| 4B | 73% |
| 5B | 76% |
| 6B | 85% |
| 6C | No Data |
| 7B | 89% |
| 8B | 68% |

For some of the samples, the reduction in viscosity was measured (see Table 5) As presented in Table 5, several compositions, some of which comprise a PACl-based coagulant modified with polyamine-based polymers, demonstrated a viscosity reduction of at least 10%, with a maximum reduction of 50% (see Table 5).

TABLE 5

| Sample | Viscosity |
|---|---|
| name | reduction |
| 1B duplicate | No data |
| 2B | 25% |
| 3B | 50% |
| 4B | 39% |
| 5B | No data |
| 6B | 47% |
| 6C | 47% |
| 7B | 33% |
| 8B | 25% |

For some of the sample of the present example, the TOC removal was measured (see Table 6). As presented in Table 6, several compositions, some of which comprise a PACl-based coagulant modified with polyamine-based polymers, demonstrated a TOC removal of 94% (see Table 6).

TABLE 6

| Sample | TOC removal, |
|---|---|
| name | % |
| 1B | No data |
| 2B | No data |
| 3B | 90% |
| 4B | 80% |
| 5B | 94% |
| 6B | 90% |
| 7B | No data |
| 8B | No data |

For some of the samples of the present example, the sludge was collected from the floatation unit and was dewatered in a centrifuge or a filter press. It was found that the dryness of the sludge generated by a PACl-based coagulant modified with two different polyamine-based polymers was 25%.

### Example 3—Coagulation Under Anaerobic Conditions

In this example, a simulated produced water sample that comprised a commercially available water soluble, high molecular weight anionic polyacrylamide-based polymer (Polymer B) and oil was prepared and treated under anaerobic conditions. The sample was treated with a composition comprising a coagulant comprising a PACl-based coagulant comprising a polyamine-based polymer (polyDADMAC) and cationic polyacrylamide which comprised acrylamide and Q9.

Samples were prepared as follows. First, a sample comprising Polymer B and oil was de-aerated by sparging with nitrogen to remove dissolved oxygen in a 1 L closed bottle. Then the bottle was placed over a magnetic mixer and the mixing speed was adjusted to 500 RPM. Once the mixing speed reached 500 RPM, the composition comprising the PACl-based coagulant was added to the sample. After 1 min. of mixing at 500 RPM, the mixing speed was reduced to 100 RPM, and the sample was mixed for 10 min. at 100 RPM. At the end of the 10 min. mixing period, water with nitrogen was introduced into the bottle to float the floc that had been formed by coagulation. Next, the contents of the bottle were filtered through a coarse filter to remove the larger flocs. The filtrate was then collected and analyzed.

Analysis of the filtrate demonstrated that by using the composition comprising the PACl-based coagulant comprising a polyamine-based polymer (polyDADMAC) and cationic polyacrylamide the concentration of Polymer B was reduced from 280 ppm to 84 ppm, and the concentration of oil was reduced from 300 ppm to 90 ppm, corresponding to an approximately 70% removal rate. It was noted that the flocs formed by the coagulation were not sticky and floated on the surface.

### Example 4—Coagulation Under Aerobic Conditions

In this example, a simulated produced water sample that comprised a commercially available water soluble, high molecular weight anionic polyacrylamide-based polymer (Polymer C) and oil was prepared and treated under aerobic conditions. The sample was treated with a composition comprising a PACl-based coagulant comprising a polyamine-based polymer (polyDADMAC) and cationic polyacrylamide which comprised acrylamide and Q9.

Samples were prepared as follows. First, the sample was poured into a 1 L beaker, and then the composition comprising a coagulant comprising a PACl-based coagulant comprising a polyamine-based polymer (polyDADMAC) and cationic polyacrylamide was added while mixing the sample at 400 RPM for 1 min. Next, the mixing speed was reduced to 100 RPM, and the sample with the added composition was mixed for 8 min. and subsequently allowed to settle for 4 min. Flocs were then floated by injection of pressurized water and nitrogen into the beak after settling (flotation time: 3 min.). After flotation of the sample, the sample was filtered through a coarse filter. Floc stickiness was checked visually (lack of floc on the mixer and/or beaker surface was considered as non-sticky floc).

The results obtained are presented in Table 8 below. The COD removal rate was 45%, the Polymer C removal rate was 78%, and the oil removal rate was 80%, thereby demonstrating the effectiveness of the treatment with the a PACl-based coagulant comprising a polyamine-based polymer (polyDADMAC) and cationic polyacrylamide. It was noted that the floc was not sticky.

TABLE 8

| | Initial | Treated sample, | Removal |
|---|---|---|---|
| Parameter | feed, ppm | ppm | rate, % |
| COD | 450 | 248 | 45 |
| Polymer C | 284 | 63 | 78 |
| Oil | 80 | 16 | 80 |

### Example 5—Produced Water Treatment

The tests of the present example were carried out using a jar test (Kemira miniflocculator). The conditions used were as follows: fast mixing at 400 rpm for 60 seconds, slow mixing at 100 rpm for 20 min followed by settling for 5 min.

A synthetic produced water was prepared by dissolving 400 ppm high molecular weight (MW) polyacrylamide with hydrolysis degree of 30 mol % in brine. The recipe of brine used is presented in Table 9.

This mixture was sheared for 30 min by pumping it through a centrifuge pump. Sheared polymer had MW of about 720 kDa and PDI (ratio of MW to Mn) of 16 (measured with size exclusion chromatography, SEC).

Further tests, as described below, included tests comprising synthetic produced fluid which was prepared by mixing 400 ppm of HPAM polymer in brine with 500 ppm of crude oil.

Additional tests, as described below, included tests comprising a field sample which has about 300 ppm of back produced water with hydrolysis of 30%.

TABLE 9

| Component | Amount for working solution, g/l |
|---|---|
| NaCl | 3.11 |
| CaCl₂•2H2O | 0.09 |
| MgCl₂•6H₂O | 0.09 |
| NaHCO₃ | 1.31 |
| KCl | 0.05 |
| Na₂SO₄•10H2O | 0.53 |

The composition of the products used in the present example are described in Table 10.

TABLE 10

| Product name | Product info |
|---|---|
| PAC 2 | Polyaluminum chloride, low basicity, 9 ± 1 wt % |
| | aluminum |
| Polyamine 1 | Polyamine, Very high MW, high charge |
| Polyamine 2 | Polyamine, High MW, very high charge |
| CPAM | High MW cationic PAM |

The test matrix of the present example was designed by MODDE®. The matrix included 4 variables (inorganic coagulant concentration, organic coagulant, organic coagulant concentration, and pH) in three levels. Response factors were HPAM polymer concentration (by Total Organic Carbon, TOC), Zeta potential, and viscosity, which values were measured from samples following treatment. For the tests involving a field sample, the polymer concentration (using SEC) and oil concentration (by using flow cytometry) were measured.

Viscosity (using Brookfield, ULA, 60 rpm), TOC (using Huber LC-OCD analyzer), and Zeta potential (using Malvern Zeta sizer) were measured from reference and treated samples. Samples for viscosity and Zeta potential measurement were filtered through a 45 μm filter. All measurements were performed at room temperature. Samples for TOC measurement were filtered through an 0.45 μm filter. Floc strength was evaluated by shearing floc with high mixing speed and visually checking for any changes in the floc size. Settling time was recorded during the settling stage and sludge volume was measured after the treatment by using a graduated cylinder.

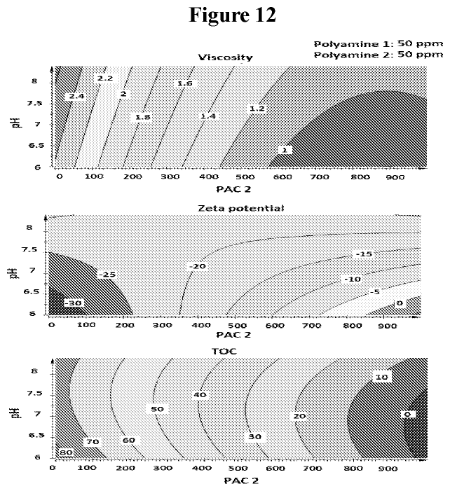

In tests used to generate the data of FIG. 12 the synthetic water contained only HPAM with concentration of 400 ppm.

The results related to the influence of a composition comprising PAC 2, 50 ppm polyamine 1, and 50 ppm polyamine 2, and the influence of pH, on solution viscosity, Zeta potential, and TOC are presented in FIG. 12.

Referring now to FIG. 12, it was observed that the effect of pH on viscosity was generally related to the PAC2 concentration, and that above 300 ppm PAC 2 concentration the viscosity decreased when the pH was reduced. It was noted that the lowest value for viscosity was obtained at the highest concentration of PAC 2 and lowest pH value. It was further noted that at the dosage of polyamines used (50 ppm polyamine 1 and 50 ppm polyamine 2) the influence of pH on TOC was reduced as evidenced by the counter plots becoming parallel to the pH axis. At these conditions, it was observed that increasing PAC 2 dosage was observed to reduce TOC, which result indicated that the composition achieved desired results over a broad pH range, particularly advantageous for work in remote areas where supplying large volumes of acid or base for pH adjustments can be a challenge and/or unfeasible.

As described above, synthetic produced fluid samples were prepared by mixing 400 ppm of HPAM polymer in brine with 500 ppm of crude oil. The effects of treatment of this produced fluid with compositions comprising PAC 2 and polyamine 1 and/or polyamine 2 were evaluated. In particular, pH before and after coagulation, floc deformation, sludge percentage (after 24 h), viscosity, and TOC were measured in the treated samples, and the results that were obtained are presented in Table 11 below.

TABLE 11

| Poly- | Poly- | | | | | Sludge | | |
|---|---|---|---|---|---|---|---|---|
| amine 1 | amine 2 | PAC 2 | pH | | Floc | percentage, | | |
| Dosage | Dosage | Dosage | prior to | pH after | deformation | % (after | Viscosity | TOC |
| ppm | ppm | ppm | Coagulation | coagulation | Yes/No | 24 h) | cP | ppm |
| Ref | | | | 8.5 | | | 2.0 | 105 |
| 0 | 0 | 1000 | 8.4 | 6.8 | Y | 100 | 0.9 | 2 |
| 0 | 50 | 1000 | 6.0 | 4.8 | N | 67 | 1.5 | 64 |
| 5 | 0 | 1000 | 7.2 | 6.8 | N | 92 | 2.4 | 55 |
| 5 | 50 | 1000 | 8.4 | 7.1 | Y | 50 | 1.0 | 70 |
| 50 | 5 | 1000 | 8.4 | 7.3 | Y | 50 | 1.5 | 72 |
| 50 | 50 | 1000 | 8.4 | 7.2 | Y | 15 | 0.8 | 2 |
| 0 | 50 | 200 | 7.2 | 6.8 | Y | 35 | 2.2 | 97 |
| 5 | 5 | 500 | 8.4 | 7.6 | Y | 26 | 1.3 | 54 |

It was observed that a composition comprising 1000 ppm PAC 2, 50 ppm polyamine 1, and 50 ppm polyamine 2 achieved both low sludge and maximum TOC removal.

As described above, further tests were conducted using a sample received from an oil field. The injected polymer was already back produced and, at the time of the test, the concentration of the polymer in the produced fluid was around 300 ppm. The sample was treated with combination of PAC 2, Polyamine 2, and CPAM. The results were compared with PAC 2 alone and are presented in Table 12.

TABLE 12

| | | | | | Dry | |
|---|---|---|---|---|---|---|
| | | Polymer | Oil | | solid of | Residual |
| | Dosage, | removal, | removal, | Sludge | sludge, | Aluminum, |
| Chemical | ppm | % | % | % | % | ppm |
| PAC 2 | 800 | 95 | 85 | 15 | 9 | 2.9 |
| PAC 2 + | 290 | 60 | 70 | 10 | 9 | 0.74 |
| Polyamine | | | | | | |
| 2 + CPAM | | | | | | |

As demonstrated by the results of Table 12, though a high degree of polymer removal was obtained when benchmark product PAC 2 was used with a high dosage (800 ppm), a large volume of viscous sludge was generated. Generation of such an amount of viscous sludge can generally clog process equipment and cause unplanned maintenance of said equipment to occur. In addition, the amount of residual aluminum in the treated water was high, which limits the reuse of treated water for polymer make up, in part due to crosslinking of residual aluminum with polymers used during EOR processes. However, as presented in Table 12, it was found that the combined product (PAC 2+Polyamine 2+CPAM) alleviated these undesirable effects. For instance, the polymer removal percentage slightly decreased but sludge volume and residual aluminum were reduced by 5% and 75%, respectively, while also achieving 60% polymer removal.

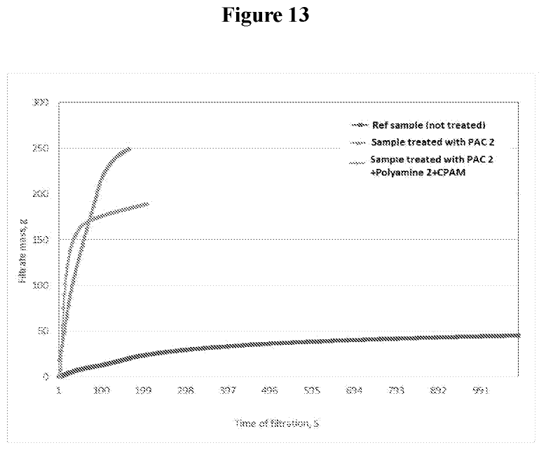

The treated sample was further evaluated by measuring the filter ratio from the EOR polymer dissolved in treated water samples (see FIG. 13). The composition comprising PAC 2+Polyamine 2+CPAM was found to improve the filtration rate as compared to PAC 2 alone (benchmark) and the reference sample (see FIG. 13).

In the preceding procedures, various steps have been described. It will, however, be evident that various modifications and changes may be made thereto, and additional procedures may be implemented, without departing from the broader scope of the procedures as set forth in the claims that follow.

1. A method for treating produced water comprising one or more water soluble polymers, which comprises treating said produced water with one or more polyaluminum chloride-based (PACl-based) coagulants.

2. The method of claim 1, wherein:
i. said one or more PACl-based coagulants are modified with one or more polyamine-based polymers;
ii. said one or more PACl-based coagulants are modified with at least two polyamine-based polymers;
iii. said one or more PACl-based coagulants are modified with one or more cationic polyacrylamides (cPAMs);
iv. said one or more PACl-based coagulants are modified with one or more polyDADMACs;
v. said one or more PACl-based coagulants are modified with one or more polyamine-based polymers and/or one or more cPAMs and/or one or more polyDADMACs;
vi. said one or more PACl-based coagulants are modified with one or more polyamine-based polymers and/or one or more cPAMs;
vii. said one or more PACl-based coagulants are modified with one or more polyDADMACs and/or one or more polyamine-based polymers;
viii. said one or more PACl-based coagulants are modified with one or more polyDADMACs and/or one or more cPAMs;
ix. the produced water is treated with an amount of said one or more PACl-based coagulants that is effective to effect one or more of the following: reduce the viscosity of the produced water; result in less sticky, floating floc; reduce the TOC of said produced water; increase the COD removal rate; reduce the oil concentration of the produced water; affect salinity in a desired manner; affect zeta potential in a desired manner; decrease the absolute charge of the treated produced water; affect the charge of the produced water in a desirable manner, i.e., the absolute charge may be reduced; the alkalinity may be altered; zeta potential/salinity may be affected; the amount of micro floc may be reduced; the sludge volume may decrease; the sludge density may increase; the sludge dryness may increase; the sludge dewatering may increase; the rate of floc formation may increase; oil removal may be enhanced; the settling rate may increase; the amount of polymer removed from produced water may increase; and/or the dewatering efficiency may increase, and the like, or any combination of the foregoing; as compared to other coagulants used to treat produced water and/or as compared to untreated produced water;
x. an amount of said one or more PACls used to treat said produced water is an amount that is effective to reduce the viscosity of the produced water and/or to remove one or more polymers from the produced water;
xi. treatment of the produced water with said one or more PACl-based coagulants results in reduction of the amount of polymer comprised in the produced water by about 50% or less, by about 50% or more, by about 55% or more, by about 60% or more, by about 65% or more, by about 70% or more, by about 75% or more, by about 80% or more, by about 85% or more, by about 90% or more, by about 95% or more, or by about 98% or more as compared to untreated produced water;
xii. treatment of the produced water with one or more PACl-based coagulants results in a reduction of the viscosity of the produced water by about 10% or less, about 10% or more, about 15% or more, about 20% or more, about 25% or more, about 30% or more, about 35% or more, about 40% or more, about 45% or more, about 50% or more, about 55% or more, about 60% or more, about 65% or more, about 70% or more, about 75% or more, about 80% or more, as compared to untreated produced water;
xiii. said produced water is generated during any part of an enhanced oil recovery process;
xiv. said produced water comprises one or more water soluble thickening or viscosifying polymers;
xv. said produced water comprises polymer flooded produced water;
xvi. treatment of the produced water with one or more PACl-based coagulants reduces the viscosity to a level that is beneficial for reinjection or which is suitable (e.g., environmentally acceptable) disposal purposes;
xvii. said treated produced water is reused in the same or other industrial processes;
xviii. said treated produced water is reused for polymer injection, backflow water application, and/or water injection;
xix. said treated produced water is used for skim tank settling;
xx. said produced water comprises one or more PAMs, such as, for example, any polymers or co-polymers comprising acrylamide moieties, one or more acrylamide (co)polymers, and/or one or more water soluble high molecular weight anionic polyacrylamide-based polymers;
xxi. said one or more PAMs comprise one or more HPAMs and/or one or more DPAMs and/or one or more sulfonated PAMs;
xxii. treatment of the produced water occurs on-site, at any onshore oil field, at any offshore oil field, at a treatment facility, at a disposal well, or at any other location where produced water is present and/or treated;
xxiii. treatment of the produced water with one or more PACl-based coagulants results in a sludge volume from about 10% to about 30% of the total volume before a dewatering and/or separation step;
xxiv. treatment of the produced water with one or more PACl-based coagulants is effected through a single treatment with said one or more PACl-based coagulants;
xxv. said treatment results in about 0.02 gram or less, 0.02 gram or more, about 0.04 gram or more, about 0.06 gram or more, about 0.08 gram or more, about 0.10 gram or more, about 0.12 gram or more, about 0.14 gram or more, or about 0.16 gram or more of said water soluble and/or viscosifying polymer removed per mMol of Al comprised by said one or more PACl-based coagulants;
xxvi. said treatment results in removal of about 40% or less, about 40% or more, about 50% or more, about 60% or more, about 70% or more, about 80% or more, about 90% or more, about 95% or more, about 96% or more, about 97% or more, about 98% or more, or about 99% or more of said one or more water soluble and/or viscosifying polymers comprised by said produced water;
xxvii. said treatment results in a COD removal rate of about 50% or less, 50% or more, 60% or more, 70% or more, 80% or more, or 91% or more;
xxviii. treatment of said produced water with one or more PACl-based coagulants results in any one or more of the following: less pH depression and/or alkalinity depletion; reduced lime or caustic requirements; reduced sludge volumes; increased sludge density; improved results in higher pH system as compared to other coagulants; minimized pH adjustment; improved filter operation; and/or improved performance in cold water as compared to other coagulants and/or untreated produced water;
xxix. said one or more water soluble polymers comprise one or more high molecular weight polymers;
xxx. said one or more water soluble polymers comprise one or more anionically charged high molecular weight polymers;
xxxi. treatment of said produced water with one or more PACl-based coagulants results in a treated produced water which meets desired effluent quality standards;
xxxii. treatment of said produced water with one or more PACl-based coagulants is used in combination with one or more additional processes, such as mechanical treatments (e.g., membrane filtration), chemical treatments (e.g., oxidizing agents), and/or biological treatments (e.g., microbiological processes);
xxxiii. said treatment occurs under anaerobic conditions;
xxxiv. said treatment occurs under aerobic conditions; and/or
xxxv. a combination of any two or more of (i)-(xxxiv).

3. The method of claim 2, embodiment (iii), wherein:
a. said one or more cPAMs comprise a copolymer comprising one or more acrylamide monomers or one or more methacrylamide monomers and one or more cationic monomers;
b. said one or more cPAMs comprise an acrylamide or methacrylamide based polymer that is also treated after the polymerization to render it cationic, for example, by using Hofmann or Mannich reactions;
c. said one or more cPAMs comprise a copolymer comprising one or more acrylamide monomers and one or more methacrylamide monomers, optionally wherein said copolymer has an average molecular weight (MW) of between about 300 000-3 000 000 g/mol, between about 400 000-2 000 000 g/mol, between about, 500 000-1 500 000 g/mol, or between about 500 000-1 000 000 g/mol; and/or
d. a combination of any two or more of a.-c.

4. The method of any one of the foregoing claims, wherein PACl, one or more polyamine based polymers, and one or more cPAMs are added simultaneously, e.g., as a mixture, are added separately, and/or are added multiple times separately or in combination.

5. The method of any one of the foregoing claims, wherein PACl, one or more polyamine based polymers, and one or more cPAMs are added in any order and/or in any combination and/or occurs multiple times, optionally wherein said separate addition of PACl, one or more polyamine-based polymers, and one or more cPAMs occur in any order, and occur in combinations, i.e., addition of one polyamine-based polymer and one cPAM occur first, followed by addition of PAC′, followed by addition of a second polyamine-based polymer and a second cPAM.

6. The method of any one of the foregoing claims, wherein PACl, one or more polyamine based polymers, and one or more cPAMs are added in one or more doses as needed or in intervals, in a stepwise fashion, or in a continuous fashion.

7. The method of any one of the foregoing claims, wherein treatment comprises adding 100 ppm or less, 100 ppm or more, 150 ppm or more, 200 ppm or more, 250 ppm or more, 300 ppm or more, 350 ppm or more, 400 ppm or more, 450 ppm or more, 500 ppm or more, 600 ppm or more, 700 ppm or more, or 800 ppm or more of said one or more PACl-based coagulants to said produced water.

8. The method of any one of the foregoing claims, wherein treatment comprises adding 5 ppm or less, 5 ppm or more, 10 ppm or more, 15 ppm or more, 20 ppm or more, 25 ppm or more, 30 ppm or more, 35 ppm or more, 40 ppm or more, 45 ppm or more, 50 ppm or more, 60 ppm or more, 70 ppm or more, 80 ppm or more, 90 ppm or more, 100 ppm or more, 150 ppm or more, 200 ppm or more, 250 ppm or more, 300 ppm or more, 350 ppm or more, 400 ppm or more, 450 ppm or more, 500 ppm or more, 600 ppm or more, 700 ppm or more, or 800 ppm or more of any one or more components of the PACl-based coagulant, such as, for example, the one or more polyamines and/or polyaluminum chloride and/or cPAMs to the produced water.

9. A composition suitable for use in treating produced water or a treated produced water composition, comprising one or more PACl-based coagulants, one or more water soluble polymers, and produced water.

10. The composition of claim 9, wherein:
i. said one or more PACl-based coagulants comprise one or more PACl-based coagulants modified with one or more polyamine-based polymers;
ii. said one or more PACl-based coagulants include PACl-based coagulants which are modified with one or more cationic polyacrylamides (cPAMs);
iii. said one or more PACl-based coagulants include PACl-based coagulants which are modified with one or more polyDADMACs;
iv. said one or more PACl-based coagulants include PACl-based coagulants which are modified with one or more polyamine-based polymers and/or one or more cPAMs and/or one or more polyDADMACs;
v. said one or more PACl-based coagulants include PACl-based coagulants which are modified with one or more polyamine-based polymers and/or one or more cPAMs;
vi. said one or more PACl-based coagulants include PACl-based coagulants which are modified with one or more polyDADMACs and/or one or more polyamine-based polymers;
vii. said one or more PACl-based coagulants include PACl-based coagulants which are modified with one or more polyDADMACs and/or one or more cPAMs;
viii. said one or more PACl-based coagulants comprise one or more PACl-based coagulants modified with at least two polyamine-based polymers;
ix. said composition comprises one or more PAMs, e.g., polymers or co-polymers comprising acrylamide moieties, e.g., one or more acrylamide (co)polymers, e.g., one or more polymers comprising acrylamide and acrylic acid;
x. said composition comprises one or more HPAMs and/or one or more DPAMs and/or one or more sulfonated PAMs;
xi. said composition comprises one or more water soluble, high molecular weight anionic polyacrylamide-based polymers;
xii. said produced water is generated during any part of an enhanced oil recovery process;
xiii. said composition comprises one or more water soluble thickening or viscosifying polymers;
xiv. said produced water comprises polymer flooded produced water;
xv. said produced water comprises one or more PAMs, e.g. polymers or co-polymers comprising acrylamide moieties, one or more acrylamide (co)polymers, and/or one or more water soluble high molecular weight anionic polyacrylamide-based polymers;
xvi. said one or more water soluble polymers comprise one or more high molecular weight polymers;
xvii. said one or more water soluble polymers comprise one or more anionically charged high molecular weight polymers; and/or
xviii. a combination of any two or more of (i)-(xvii).

11. The composition of any one of claims 9-10, wherein said composition comprises one or more cPAMS, and further wherein:
a. said one or more cPAMs comprise a copolymer comprising one or more acrylamide monomers or one or more methacrylamide monomers and one or more cationic monomers;
b. said one or more cPAMs comprise an acrylamide or methacrylamide based polymer that is also treated after the polymerization to render it cationic, for example, by using Hofmann or Mannich reactions;
c. said one or more cPAMs comprise a copolymer comprising one or more acrylamide monomers and one or more methacrylamide monomers, optionally wherein said copolymer has an average molecular weight (MW) of between about 300 000-3 000 000 g/mol, between about 400 000-2 000 000 g/mol, between about, 500 000-1 500 000 g/mol, or between about 500 000-1 000 000 g/mol and/or
d. a combination of any two or more of a.-c.

12. The composition of any one of claims 9-11, wherein said composition comprises 100 ppm or less, 100 ppm or more, 150 ppm or more, 200 ppm or more, 250 ppm or more, 300 ppm or more, 350 ppm or more, 400 ppm or more, 450 ppm or more, 500 ppm or more, 600 ppm or more, 700 ppm or more, or 800 ppm or more of said one or more PACl-based coagulants.

13. The composition of any one of claims 9-12, wherein said composition comprises 5 ppm or less, 5 ppm or more, 10 ppm or more, 15 ppm or more, 20 ppm or more, 25 ppm or more, 30 ppm or more, 35 ppm or more, 40 ppm or more, 45 ppm or more, 50 ppm or more, 60 ppm or more, 70 ppm or more, 80 ppm or more, 90 ppm or more, 100 ppm or more, 150 ppm or more, 200 ppm or more, 250 ppm or more, 300 ppm or more, 350 ppm or more, 400 ppm or more, 450 ppm or more, 500 ppm or more, 600 ppm or more, 700 ppm or more, or 800 ppm or more of any one or more components of the PACl-based coagulant, such as, for example, the one or more polyamines and/or polyaluminum chloride and/or cPAMs.
